(19) United States
(12) Patent Application Publication
(10) Pub. No.: US 2015/0066594 A1
(43) Pub. Date: Mar. 5, 2015

(54) SYSTEM, METHOD AND COMPUTER ACCESSIBLE MEDIUM FOR DETERMINING ONE OR MORE EFFECTS OF RANKINGS ON CONSUMER BEHAVIOR

(71) Applicants: BEIBEI LI, Pittsburgh, PA (US); ANINDYA GHOSE, New York, NY (US); PANAGIOTIS G. IPEIROTIS, New York, NY (US)

(72) Inventors: BEIBEI LI, Pittsburgh, PA (US); ANINDYA GHOSE, New York, NY (US); PANAGIOTIS G. IPEIROTIS, New York, NY (US)

(73) Assignee: New York University, New York, NY (US)

(21) Appl. No.: 14/467,264

(22) Filed: Aug. 25, 2014

Related U.S. Application Data
(60) Provisional application No. 61/870,462, filed on Aug. 27, 2013.

(51) Int. Cl. G06Q 30/02

(52) U.S. Cl. CPC G06Q 30/0202
USPC 705/7.31

(57) ABSTRACT

Exemplary systems, methods and computer-accessible mediums can be provided which can receive information related to a consumer(s), and determine the search behavior of the consumer(s) based on the information and using a consumer search model that is based on heterogeneous preferences and a search cost model of a second consumer(s).

### CROSS-REFERENCE TO RELATED APPLICATIONS

This application relates to and claims priority from U.S. Patent Application No. 61/870,462, filed on Aug. 27, 2013, the entire disclosure of which is incorporated herein by reference.

### FIELD OF THE DISCLOSURE

The present disclosure relates generally to determining consumer behavior based on rakings, and more specifically, to exemplary embodiments of systems, methods and computer-accessible mediums for determining consumer behavior and/or effects thereon, based on, for example, search engine rankings

### BACKGROUND INFORMATION

Over the past year, search engines have emerged as a significant channel for promoting and selling products. In information search engines (e.g., Google, Bing and Yahoo), the ranking of the search results is an immediate signal of the relevance of the result to the query. However, in product search engines, the ranking of the displayed products is often based on criteria such as price, product rating, etc. In such a setting, there can often be multiple, potentially conflicting, signals given to the customer about the ranking of the products. For example, if the ranking is performed by price, then the cheapest products sometimes have low product ratings. Additionally products appearing on top of the list can be too expensive for the customer. Consumers have to observe multiple, competing and ranking signals, and then have to come up with their own ranking in their minds. In some settings, the product search engine will also generate personalized results, trying to rank the products according to the preferences of the consumer. In such environment, it can be beneficial to understand which factors influence the decision-making process of the customers, and what the magnitude of the influence can be on the customer. It may be preferable to determine whether consumers are influenced by the display ranking order, by the product rating, by price, and in what degree and how does this interplay affect the revenue that a search engine can generate.

There is an existence of a strong primacy effect in environments, where consumers make choices among offers displayed in information search engines. For example, online position effect can exist, and rank order can have a significant impact on the click-through rates and conversion rates. (See, e.g., References 70, 19, 72, 1, 59, 71, 65 and 48). Previous literature focused primarily on evaluating the effect of screen position on user behavior, controlling for the quality of the advertisement. However, in product search engines, the observed demand patterns can be influenced by the joint variation in product ratings (e.g. either professional rating or user rating) and online screen position. Thus, one of the goals can be to examine the position effect in product search engines, which can be conditional on its interaction with product ratings.

Search engines are beginning to adopt signals from social media sites directly into their ranking mechanism design (e.g., Bing Social Search and TripAdvisor). Recently, it was indicated that a utility-based ranking mechanism on product search engines that incorporates multidimensional consumer preferences, and social media signals, can lead to significant surplus gain for consumers. (See, e.g., Reference 18). However, given that price was not the top priority considered in the ranking recommendation, whether such mechanism can actually benefit product search engines may not be clear, because their revenues are normally commission based. Therefore, a further goal can be to examine the effect of different ranking mechanisms on product search engine revenue.

In addition to searching for a product, one of the important ways for shoppers to discover products can be through recommendation engines. (See, e.g., Reference 54). However, while some online retailers use recommendation systems, many product-specific search engines (e.g., travel search engines) still do not provide personalized ranking results in response to consumer queries, presumably because these product search engine companies can be unsure whether providing extra information to consumers will lead to an increase in profit. Existing research shows differences on the effects of personalization. Some research has supported personalization (see, e.g., References 63, 68, 49, 51, 73), whereas other research was a bit more skeptical (see, e.g., References 74, 50, 20, 61), suggesting that although personalization can lead to higher customer satisfaction and profits, it does not work as well universally. However, none of these publications have examined the effect of information availability and personalization in a search engine context.

Other methods examine consumer search behavior on travel search engines through the formation of consideration sets. (See, e.g., References 10, 31). For example, secondary data can be used to examine how the sorting and filtering tools on travel search engines can influence consumer hotel searches. Results have shown a significant increase in total search activities, but can also lead to lower overall welfare due to the disproportional engagement induced by the refinement tools. Thus, a further goal can be to examine how different kinds of personalized ranking mechanisms in product search engines can affect consumer behavior and search engine revenues. Specifically, it can be beneficial to examine whether allowing users to interact with the ranking procedures to proactively personalize their search results can lead to more or fewer purchases.

With the growing pervasiveness of social media, the volume and complexity of information that needs to be accessed by product search engines from their own platforms has been increasing rapidly. For example, websites such as Amazon.com, TripAdvisor.com or Yelp.com can easily attract hundreds or even thousands of review postings that constantly compete for a user's attention. Excess content can hinder consumers from efficiently seeking information and making decisions. More importantly, the onslaught of the exploding social media content can cause significant latency in the delivery of results on product search engines. Additionally, degradation in website performance can cause an unexpected termination of a search, and in the long run, can even discourage consumers from visiting the site. A study by Jupiter Research shows that online shopper loyalty can be highly contingent upon quick web page loading. 33% of consumers shopping via a broadband connection will wait no more than four seconds for a web page to render. (See, e.g., Reference 28).

Traditional web search engines use web caching and prefetching as one of the most effective techniques to alleviate search engine bottleneck and reduce network traffic. Caching and prefetching are browser mechanisms which utilize browser idle time to download or prefetch documents that the user might visit in the near future. A web page provides a set of prefetching hints to the browser, and after the browser is finished loading the page, it begins silently prefetching specified documents and stores them in its cache. When the user visits one of the prefetched documents, it can be served up quickly out of the browser's cache.

During the past few years, a few studies have focused on designing caching frameworks (see, e.g., Reference 32), using static (e.g., offline) or dynamic (e.g., online) cache strategies. However, existing strategies likely do not work well for commercial product search engines. First, many current caching strategies can be based on user search history (e.g., caching the web pages that were requested in the past based on frequency or recency). This approach can fail to locate web pages for new customers in an online shopping scenario because of the well-known “cold start” problem. Moreover, even for repeat customers, their shopping goals or preferences can change greatly over time under different shopping contexts. For example, a customer who has searched for Wall Street Inn in New York City for a business trip is unlikely to search for it again when planning a romantic getaway on Valentine's Day in New York City. Second, search engines have been trying to improve the search history-based caching by prefetching web pages that they predict are going to be requested shortly. (See, e.g., Reference 27). However, these predictions can be based on the document relevance of web pages in response to a search query. Such design violates the goal of commercial product search engines. Instead of providing the most relevant documents, the search engine should seek to display products with the highest value for money to consumers. (See, e.g., Reference 18). Furthermore, current prefetching and predictive caching strategies assume that consumers do not have search costs, and therefore search exhaustively. As a result, under the criterion of document relevance, caching will be equally exerted for items associated with different search costs (e.g., product listed on Page 1 vs. product listed on Page 10 of the search results). However, prior work on search engine settings has shown that consumers can be highly unlikely to reach the 10th page, leading to little benefit from caching. (See, e.g., Reference 25).

An alternative approach to increase product search engine performance, and user experience, can be to improve the ranking mechanism. (See, e.g., Reference 18). Since consumers want the most desirable results early on, instead of caching, search engines can also reorder the results by their predicted probability of clicks and conversions. However, many times commercial product search engines can be committed to presenting a given ranking (e.g., due to commercial agreements) and cannot, or do not want, to intervene in consumer search. In addition, even when they are able to reorder the items, they still face the same potential problem of latency in the loading of the product's landing page. Thus, it can be important for product search engines to cache the “most likely-to-be-visited” pages beforehand to improve the response rate.

Furthermore, mobile internet usage has overtaken PC internet usage, especially in the area of travel. As modern mobile applications demand performance that can be comparable with desktop machines, it can be important to consider web caching and prefetching strategies for users accessing product search engines using mobile devices. Data access optimization and caching can be key factors that can dramatically improve response time and therefore user experience. Web caching in mobile networks can be critical due to the unprecedented cellular traffic growth that far exceeds the deployment of cellular infrastructures. The user experience improvement brought by caching can be more notable in cellular networks where the latency can usually be higher than those in wireless (e.g., Wi-Fi) and wired networks.

Thus, it may be beneficial to provide an exemplary system, method and computer-accessible medium that can evaluate different sorting methods, and which can overcome at least some of the deficiencies described herein above.

### SUMMARY OF EXEMPLARY EMBODIMENTS

Exemplary systems, methods and computer-accessible mediums can be provided which can receive information related to a first consumer(s), and determine the search behavior of the first consumer(s) based on the information and using a consumer search model that is based on heterogeneous preferences and a search cost model of a second consumer(s). The search cost model can include a random coefficient function, which can be based on a specific product. The search cost model can be based on social media information, and can include information related to a specific product(s). The search cost can be based on a cost for refining a search, and/or a transaction(s) of the second consumer(s). The exemplary search cost model can be further based on a lognormal distribution and/or a mean search cost of an observed average size of a search-generated consideration set of the second consumer(s).

In some exemplary embodiments of the present disclosure, the consumer search model can be further based on a click-through(s) from each ranking position on a page of a product(s), on an effort(s) of the second consumer(s) to refine a search procedure and/or on a hierarchical Bayesian framework. A webpage can be cached that the first consumer(s) can be likely to visit based on the search behavior. In some exemplary embodiments of the present disclosure, a ranking procedure can be generated for the first consumer(s) based on the search behavior. The information can be a current search history of the first consumer(s) or a previous search history of the first consumer(s).

In certain exemplary embodiments of the present disclosure, the search behavior of the first consumer(s) can include a probability that the first consumer(s) will click on a specific product or a purchase the specific product. The heterogeneous preferences can be based on search data of the second consumer(s). The search data can be based on a difference between a predicted click probability of the second consumer(s) and an observed click probability of the second consumer(s). The search cost model can be generated using a Maximum Simulated Likelihood procedure, which can be a Monte Carlo procedure.

These and other objects, features and advantages of the exemplary embodiments of the present disclosure will become apparent upon reading the following detailed description of the exemplary embodiments of the present disclosure, when taken in conjunction with the appended claims.

### BRIEF DESCRIPTION OF THE DRAWINGS

Further objects, features and advantages of the present disclosure will become apparent from the following detailed description taken in conjunction with the accompanying Figures showing illustrative embodiments of the present disclosure, in which:

FIGS. 1A and 1B are diagrams of exemplary search paths of an exemplary consumer according to an exemplary embodiment of the present disclosure;

FIG. 2A is an exemplary graph illustrating a distribution of a number of pages browsed during an exemplary session according to an exemplary embodiment of the present disclosure;

FIG. 2B is an exemplary graph illustrating the distribution of a number of click-throughs per page during an exemplary session according to an exemplary embodiment of the present disclosure;

FIG. 3 is an exemplary screenshot of the search results page from Travelocity.com;

FIG. 4 is an exemplary screenshot of an exemplary search interface for a hotel search engine according to an exemplary embodiment of the present disclosure;

FIG. 5 is an exemplary screenshot of an exemplary hotel landing page according to an exemplary embodiment of the present disclosure;

FIG. 6 is an exemplary screenshot of an exemplary introduction page according to an exemplary embodiment of the present disclosure;

FIG. 7 is an exemplary screenshot of an exemplary introduction page according to an exemplary embodiment of the present disclosure;

FIG. 8 is an exemplary screenshot of an exemplary search interface page according to an exemplary embodiment of the present disclosure;

FIG. 9 is an exemplary flow chart of an exemplary method for determining consumer search behavior; and

FIG. 10 is an illustration of an exemplary block diagram of an exemplary system in accordance with certain exemplary embodiments of the present disclosure.

Throughout the drawings, the same reference numerals and characters, unless otherwise stated, are used to denote like features, elements, components or portions of the illustrated embodiments. Moreover, while the present disclosure will now be described in detail with reference to the figures, it is done so in connection with the illustrative embodiments and is not limited by the particular embodiments illustrated in the figures and provided in appended claims.

### DETAILED DESCRIPTION OF EXEMPLARY EMBODIMENTS

The exemplary system, method and computer accessible medium, according to an exemplary embodiment of the present disclosure, can be used for predictive caching for search engines to prefetch consumers' dynamic search paths by taking into accounts consumers' heterogeneous preferences and search costs. To further understand the exemplary system, method and computer accessible medium, the following example can be considered, with reference to the exemplary diagrams shown in FUGS. 1A and 1B.

### EXAMPLE 1

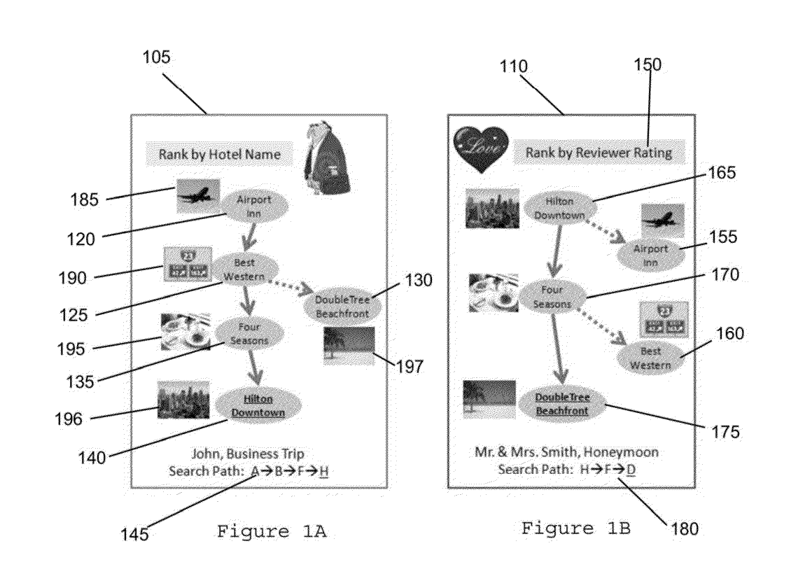

Consumer Search Path: Two different consumers try to book hotels online for their upcoming trip to Miami, Fla.: 1) John Doe, an IT consultant, is going on a business trip, and performs a search 105 and 2) Mr. Smith is going on a honeymoon trip with his spouse and performs a search 110. They both go to Travelocity.com and start searching. John chooses to sort all hotels by name (e.g., element 115). After that, he starts by clicking “Airport Inn” 120 and “Best Western” 125, skips “DoubleTree” 130, and clicks “Four Seasons,” 135. Finally, he clicks “Hilton Downtown” 140 and decides to stop searching and make a reservation in it. John Doe's search path can be seen in element 145, where the first letter in a hotel name can represent that hotel and underline can be used to denote the final purchase. Then in this scenario, John's search path is A→B→F→H. Similarly, suppose Mr. Smith, in search path 110 chooses to sort hotels by review rating 150. He skips “Airport Inn” 155 and “Best Western” 160, and clicks on Hilton 165 and Four Seasons 170. He stops searching after clicking “DoubleTree” and decides to make a reservation in it. His search path thus contains three hotels H→F→D. FIGS. 1A and 1B also illustrate the major characteristic of each hotel indicated by the corresponding image (e.g., near airport 185, highway exit 190, good restaurants 195, downtown 196, beach 197).

A challenge in predicting consumer choice with search cost can be to simultaneously identify consumers' heterogeneous preferences and search costs. (See, e.g., References 43, 24). A consumer can stop searching either because of a high valuation for the products already found, or because of a high search cost. The same observed search outcome can be explained either by the preferences for product characteristics or by the moments of the search cost distribution. (See, e.g., Reference 31). An important goal can be to identify heterogeneous search costs under the social media context and examine its effect on consumer search behavior. An exemplary identification strategy can rely on the fact that consumer preferences can enter in both the search and purchase decision-making processes, whereas consumer search cost may enter only the search decision-making process. Once the consideration set can be generated after the search, the conditional purchase decision may depend only on the consumer preferences. The exemplary unique dataset containing both consumer search and purchase information can facilitate a successfully identification of these two exemplary effects.

The exemplary system, method and computer-accessible medium, according to an exemplary embodiment of the present disclosure, can combine an optimal stopping framework with an individual-level random utility choice model. The exemplary system, method and computer-accessible medium, according to an exemplary embodiment of the present disclosure, can facilitate the ability to jointly estimate consumers' heterogeneous preferences and search costs. Based on the analytical results, the probability that a consumer will click or purchase a certain product can be predicted, and therefore, a probability-based search path for the consumer can be predicted.

The exemplary model can be validated on a unique dataset from the online hotel search industry. Detailed individual-level search and transaction data from November 2008 through January 2009 was obtained, which contained approximately one million online sessions for 2117 hotels in the United States on Travelocity.com. The exemplary model can provide more precise measures of consumer price sensitivity, and heterogeneous preferences, than a static model that does not account for consumer search cost. Moreover, the exemplary model can demonstrate the best performance in predicting the consumer click and purchase probabilities compared to other existing benchmark models. Specifically, there was a 13.16% and a 22.02% improvement in predictive power of the exemplary model compared to the next best performing model, with respect to click-through and conversion probabilities, respectively.

The exemplary model can build on an optimal sequential search framework. (See, e.g., Reference 45). However, the exemplary model can differ from previously known models in the following ways: (a) the exemplary model can incorporate not only consumers' search behaviors, but also consumers' purchases. Other studies/models consider consumers' search information only as an approximation of their actual purchase decisions; (b) the exemplary observations can include detailed click-throughs from each ranking position on a page, which can facilitate the ability to precisely model the individual click probability for a product, rather than for only a page with a bundle of products (e.g., a page of 15 hotels). (See, e.g., Reference 31); (c) the exemplary analysis can be conducted at the individual-consumer level as opposed to being performed at the aggregate market level. (See, e.g., References 30, 6); (d) the exemplary model can incorporate consumers' efforts to refine their searches (e.g., choosing to customize the ranking method), as well as an examination of the search costs associated with the refinement tools. Consumer search refinement can be modeled, and the actual search/click can be modeled as separate procedures. This can be different from previously known methods that assume zero costs of refinement and, therefore, treat search refinement as a prerequisite to consumer search (see, e.g., Reference 10); and (e) a goal can be to use the structural econometric approach as a tool for predictive digital analytics by product search engines to improve their web caching strategy and user experience. This can reduce search cost, and increase market efficiency. A summary of the differences between the exemplary system, method and computer-accessible medium and the existing studies/models is shown in Table 1 below.

TABLE 1
Comparison with Recent Literature

| | Kim, | Bronnenberg, | | | The Exemplary |
|---|---|---|---|---|---|
| | Albuquerque & | Albuquerque | | Yao & | System, Method |
| | Bronnenberg | & Kim | Koulayev | Chen | and Computer- |
| | (2010) | (2012) | (2012) | (2012) | Accessible Medium |
| Data | Amazon, | Amazon, | Hotels Click | Hotels Click, | Hotels, Click, |
| | View-Rank, | View-Rank, | (page), | Purchase, | Purchase, ~1M |
| | 18 months | Sale-Rank, | 1 month, | 215 sessions, | sessions, 3 |
| | | 18 months | (Chicago) | 15 days | months, 2117 hotels |
| Level of | Market | Market | Page | Individual | Individual |
| Analysis | | | | | |
| Real | No | No | No | Yes | Yes |
| Transactions | | | | | |
| Search | No | No | No | Yes | Yes |
| Refinements | | | | | |
| Costs for | No | No | No | No | Yes |
| Refinements | | | | | |
| Social | No | Yes | No | No | Yes |
| Media | | | | | |
| Major | Consumer | Market | Price | Search | Predict Search |
| Indications | Welfare, Market | Structure, | Sensitivity | Refinement | Paths, Price |
| | Structure | Innovation | | →Welfare | Sensitivity, |
| | | | | Decrease | “Social” Costs, |
| | | | | | Ranking Polarizes |
| | | | | | Search Cost |

### Exemplary Bounded Rationality and Satisficing Consumer

The exemplary system, method and computer-accessible medium can utilize the theory of bounded rationality and consumer satisficing behavior. Classical economic theory postulates that consumers seek to maximize their utility across different decisions. The theory of utility-maximizing choice has been the predominant framework for empirical analyses of consumer choice. (See, e.g., References 4, 33 and, 34). However, the assumption that a rational consumer has unlimited cognitive capabilities to acquire full information on the universal choice set has long been challenged as being inapplicable to actual human decision makers. (See, e.g., References 26, 29 and 42). For example, people make decisions to meet an acceptability threshold (e.g., following a “satisficing” process that combines “satisfy” with “suffice”). Cognitive limitations in human decision-making coined the term (e.g., “bounded rationality”), which can be taken into account. (See, e.g., Reference 42). A satisfying behavior-based model can better explain the observed limited consumer search and choice under incomplete information. (See, e.g., Reference 8). In particular, recent studies have found that disregarding consumers' cognitive limitations and the limited nature of choice sets can lead to biased estimates of demand. (See, e.g., References 7, 11, 30 and 35).

### Exemplary Search Cost and Consumer Information Search

The exemplary system, method and computer-accessible medium, according to an exemplary embodiment of the present disclosure, can build on the knowledge of search cost and consumer search information. The existing literature holds two different views of the nature of consumer search: (a) non-sequential and (b) sequential search. The former strand of research assumes that consumers first sample a fixed number of alternatives and then choose the best from among them. (See, e.g., References 35, 37 and 44). In contrast, other views, arising from the job-search literature argue that the actual consumer search should follow a sequential model in which consumers keep searching until the marginal cost of an extra search exceeds the expected marginal benefit. It can be assumed that consumers search sequentially on product search engines. This assumption can be consistent with the mainstream research by the web search community. (See, e.g., Reference 9). In addition, many recent studies in economics and marketing have also adopted the sequential search strategy for examining consumer search in an online environment. (See, e.g., References 5, 6, 10, 30 and 31).

Although theoretical research has been performed in this field, due to model complexity and data limitations, there has been very little empirical work performed to date. A structural methodology can be developed to recover search cost from price data only. (See, e.g., Reference 22). This can be extended to the oligopoly case and can provide a maximum likelihood estimate of the search cost distribution. (See, e.g., References 22 and 36). Markets can be examined with differentiated goods, and a sequential search model can be developed to recover search cost from the utility distribution. (See, e.g., Reference 24). More recent empirical studies on non-sequential search tend to focus on the offline market with search frictions to study price dispersion (see, e.g., Reference 46), endogenous choice sets and demand (see, e.g., Reference 37), or the identification of search cost from switching cost. (See, e.g., Reference 23). Recent empirical work on sequential search examines consumers' limited search and the associated demand, with a focus on the online search market. (See, e.g., References 30 and 31). Additionally, previous methods use web browsing and purchasing behavior based on book price distribution across 14 online bookstores to compare to the extent to which consumers are searching under non-sequential and sequential search models. (See, e.g., Reference 13).

One common practice in existing empirical studies on both types of search models can be that they typically model search cost as an inherent attribute of the consumer. Two exceptions can be (a) modeling search cost as a function of the product's appearance frequency on Amazon.com, and (b) considering explanatory variables such as geographic distance from a consumer's home to different car dealerships. (See, e.g., References 30 and 37). In the exemplary model, search cost may not only be an inherent attribute of a consumer, but also a consequence of the social media context in which consumers of today are embedded. By modeling consumer search cost as a random-coefficient function of product-specific and associated social media variables, the nature of search cost can be examined given the interplay between product search engines and social media.

### Exemplary Search Engine Caching and Ranking

The exemplary system, method and computer accessible medium, according to an exemplary embodiments of the present disclosure, can utilize literature on search engine caching and ranking During the past twenty years, many studies have examined the capability of web search engines to estimate and cache search results, in advance, that can be likely to be requested in the future. For example, previous methods present a Probability Driven Caching strategy based on a probabilistic model of search engine users, and investigated the impact of query result prefetching on the efficiency and effectiveness of web search engines. (See, e.g., Reference 27 and 32) Both offline and online caching strategies can be used for selecting and ordering queries whose results are to be prefetched. Examining the rank position effect on the click-through rate (“CTR”) and conversion rate (“CR”) on search engines has attracted a lot of attention. A number of recent studies focus on the context of search engine-based keyword advertising and found significant empirical evidence on the rank order effect. (See, e.g., References 1, 19, 20 and 47). Other studies focus on search engine ranking for commercial products. For example, a unique dataset on clicks from one of Yahoo's price comparison sites can be used to estimate the search engine ranking effect on clicks received by online retailers. (See, e.g., Reference 3). There has also been a focus on the competition of retailers ranked on price search engines, which found that the easy price search makes demand highly price-sensitive for some products. (See, e.g., Reference 15). Additionally, a new utility gain-based ranking approach has been proposed that can account for consumer multidimensional preferences and can recommend products with the highest expected utility. (See, e.g., Reference 18).

### Exemplary Data

The exemplary dataset used to test the exemplary system, method, and computer-accessible medium, came from Travelocity.com, a leading online travel search agency. The dataset contained detailed information on session-level consumer search, click and purchase events from November 2008 through January 2009, with a total of approximately one million sessions for a random sample of 2117 hotels in the United States. A typical online session can involve the following events: (a) the initialization of the session; (b) the search query; (c) the hotel listings returned from that search query in a particular rank order; (d) whether the consumer has used any special sorting criteria to rerank the hotels; (e) clicks on any hotel listing; (f) the login and actual transactions in a given hotel; and (g) the termination of the session. There was also information related to each event for every corresponding hotel, such as the nightly price and the hotel's position in the set of listings returned by the search engine (e.g., “Page” and “Rank”). The detailed transaction-level information from Travelocity.com was obtained that linked to the entire session-level consumer search data, including the final transaction price, the number of room units and nights purchased in each transaction. This was used by the exemplary system, method and computer-accessible medium to model consumer preferences for both the search and the purchase processes.

The exemplary data also included additional hotel-related information from Travelocity.com such as hotel class, hotel brand, number of amenities, number of rooms, reviewer rating, number of reviews, and the textual content of all the reviews up to Jan. 31, 2009 (e.g., the last date of transactions in the exemplary database). To capture consumers' cognitive costs in reading reviews, two sets of review text features were analyzed that can be likely to affect consumers' intellectual efforts in internalizing review content: (a) “readability” (e.g., complexity, syllables and spelling errors) and (b) “subjectivity” (e.g., mean and standard deviation). Both of them have been found to have had significant impact on product sales in the past. (See, e.g., Reference 17). To derive the probability of subjectivity in the review's textual content, a standard text mining technique can be applied. In particular, a classifier can be trained using as “objective” documents the hotel descriptions of each of the hotels in the exemplary dataset. 1000 reviews were randomly retrieved to construct the “subjective” examples in the training set. The training process was conducted using a 4-gram Dynamic Language Model classifier provided by the LingPipe toolkit (e.g. http://alias-i.com/lingpipe/). Thus, a subjectivity confidence score was acquired for each sentence in a review, and the mean and variance of this score was derived, which can represent the probability of the review being subjective.

In addition, there was also supplemental data on hotel location-related characteristics collected independently. Geo-mapping search tools were used (e.g., Bing Maps API) and social geo-tags (e.g. from geonames.org) to identify the number of external amenities (e.g., shops, bars, etc.) in the area around the hotel. Image classification techniques were used together with human annotations (e.g., from Amazon Mechanical Turk, (“AMT”)) to examine whether or not there is a nearby beach, lake or downtown area, and whether the hotel is close to a highway or public transportation. These characteristics were extracted within an area of 0.25-mile, 0.5 mile, 1-mile and 2-mile radius, although not limited thereto. Local crime rate from FBI statistics was also obtained. For a better understanding of the variables in the exemplary setting, the definitions and summary statistics of all variables are presented in Table 2. Notice that the exemplary data set used can be significantly different from those previously used. (See, e.g., Reference 18). The exemplary system, method and computer-accessible medium, according to an exemplary embodiment of the present disclosure, can use not only the transaction data (e.g., purchases), but the complete session-level data (e.g., both clicks and purchases). The resulting data set contained approximately seven million observations from one million individual user sessions, compared to a much smaller set of 8099 observations containing only the purchase information. (See, e.g., Reference 18).

### Exemplary Model-Free Evidence of Limited Search by Consumers

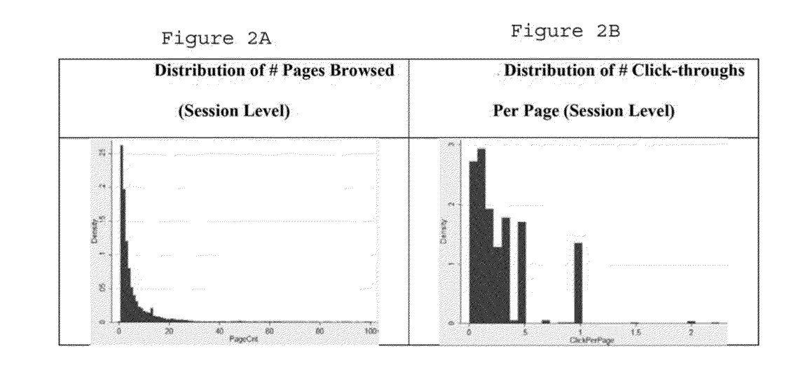

The distribution of the total number of pages a consumer browses in her search session can be plotted. FIG. 2A illustrates this exemplary distribution in detail, with the x-axis representing the page counts and the y-axis representing the density. As shown in FIG. 2A, over 25% of consumers browse only one page; over 50% of consumers browse less than three pages; and less than 10% of consumers browse more than 15 pages during their search for hotels. This finding is consistent with prior industry evidence that consumers seldom search more than three pages. (See, e.g., Reference 25). Second, the distribution of the average number of click-throughs made per page during each search session can be further examined. FIG. 2B illustrates this distribution, with the x-axis representing the click-throughs per page and the y-axis representing the density. As shown in FIG. 2B, on average, consumers click less than one hotel out of a total of 25 hotels per page during their search. In fact, a large majority of consumers click less than 0.5 hotels per page, on average. These exemplary figures provide preliminary evidence that consumers' incur non-trivial search costs in this context and that consumer search can be limited.

### Exemplary Structural Model of Consumer Sequential Search

In the exemplary dataset, the complete browsing session, and the purchasing decisions that consumers made can be available. Consumers can have three options for a hotel during a search session: A) Do not click on the hotel at all; B) Click on the hotel but do not purchase it; C) Click on the hotel and also purchase it. To identify option A from options B and C, consumers' click decision making can be modeled. To identify option B from option C, consumers' purchase decision making can be modeled. The exemplary system, method and computer-accessible medium, according to an exemplary embodiment of the present disclosure, can utilize a holistic model of user behavior that can model both the clicking and purchasing behavior. The exemplary model can work as follows.

A consumer session can start with a series of clicks r(1), . . . r(Nᵢ), where the consumer visits the “details” landing pages of hotels, and estimates the utility that can be expected to be obtained from the hotel. The consumer can stop exploring new hotels and stop clicking, when the expected marginal benefit of adding an additional hotel in the consideration set can be less than the expected cost of searching. The concept of “reservation utility” can be adopted to define when the consumer stops exploring. (See, e.g., Reference 45). Once the consumer stops searching, the consideration set can be fixed, and the consumer can make a decision to purchase one of the hotels in the choice set, or skip purchasing anything at all.

### Exemplary Model Setting

### Exemplary Product Utility

Assume the utility of hotel j for consumer i to be a random-coefficient model, for example, as follows:

u ᵢⱼ=Vᵢⱼ+eᵢⱼ, (1)

where Vᵢⱼ can represent the expectation of the overall hotel utility. Xⱼ can be a vector of characteristics for hotel j, Pⱼ can represent the price for hotel j. Thus, the expected utility can be modeled as Vᵢⱼ=Xⱼβᵢ—where βᵢ and αᵢ can be consumer-specific parameters that can capture the heterogeneous preferences of consumers. It can be assumed that βᵢ˜N( β̅, Σ_{β}) where β̅ can be a vector containing the means of the random effects and Σ_{β} can be a diagonal matrix containing the variances of the random effects. Moreover, it can be assumed that αᵢ˜N ( α̅, σ_{α}²). Thus, the overall utility function can be written as, for example:

uᵢⱼ=Xⱼβₜ−αᵢPⱼ+eᵢⱼ. (2)

Note that eᵢⱼ can represent the unknown stochastic error during the consumer's decision process. It can be assumed to be i.i.d. across consumers and hotels. For estimation tractability, it can be assumed to follow a Type I Extreme Value distribution eᵢⱼ—Type I EV(0,1).

Exemplary Search Cost

Consumers' search costs can be modeled to account for different dimensions in their evaluation of hotel-related information, including both the structured product information (e.g., hotel owner-provided descriptions) and the unstructured product information (e.g., social media content generated by the online communities). Eye-tracking studies have shown that consumers tend to scan the search results in order (see, e.g., Reference 2), and visual attention can influence consumer choice. (See, e.g., Reference 39). Thus, the hotel's online screen position can also have a significant effect on consumer search cost. Qⱼ can denote the set of variables that capture the above three dimensions of consumer information search for hotel j. The search cost of consumer i for hotel j can be modeled to follow a lognormal distribution, which can be, for example:

cᵢⱼ=exp(Qⱼγᵢ). (3)

where γᵢ˜N _{γ̅}, Σ_{γ}, γ̅ can be a vector containing the means of the random effects and Σ_{γ} can be a diagonal matrix containing the variances of the random effects.

Exemplary Problem Description and the Optimal Search Framework

In general, the exemplary consumer search problem can be described as follows. Assume that a consumer searches sequentially (e.g., examines alternatives one by one) to find a hotel. At each stage of the search, the consumer has two options: (A) to continue to search for the next alternative or (B) to stop and purchase the current best alternative (e.g., including purchasing nothing such as an outside good). Consider that the consumer can be forward-looking This situation can imply that at any stage during a user's search, the user always tries to choose an action that maximizes her expected utility from the current stage going forward; meaning that the user tries to maximize the marginal benefits from both the current stage and all potential future stages. Therefore, the key problem here can be to determine when is the optimal point for the consumer to choose the “stop” option.

The exemplary system, method and computer accessible medium, according to an exemplary embodiment of the present disclosure, can build on optimal sequential search framework. (See, e.g., Reference 45). For example, an optimal stopping rule can be utilized in which alternatives can be ranked in descending order of their reservation utility. The intuition can be that this value can indicate a “rate of return” from searching each alternative. A consumer can search sequentially according to the ranking list. The consumer stops searching if the utility from the current best alternative exceeds the reservation utility of the next best alternative. Otherwise, the consumer continues to search the next alternative in the ranking and repeats the process until the consumer finds an alternative that meets the stopping criterion.

Reservation utility plays an important role in this exemplary model framework. It can be defined as the utility value for an alternative at which the consumer would be indifferent between searching the alternative at a certain cost or accepting this utility value and stopping. In other words, the reservation utility can be the value that can satisfy the boundary condition where the marginal cost of searching an extra alternative can equal the expected marginal benefits. If the consumer already has an item of higher utility, the consumer should stop since the expected marginal benefits from search can be less than the cost. If the consumer does not have a utility as high as the forthcoming reservation utility in the ranking list, the consumer should continue to search because the expected marginal benefits will exceed the expected cost.

More formally, let uᵢ* be the current highest utility searched by consumer i so far. Let zᵢⱼ be the reservation utility of hotel j for consumer i, and let J be the total number of hotels available in the market. Thus, for each consumer i, the hotels can be ranked in descending order of their reservation utility z_{y}. The exemplary rank order can be denoted by rᵢ(1) . . . rᵢ(J), where, for example:

z_{i,η(1)}, z_{i,η(2)}, z_{i,η(3)} . . . , z_{i,η(J)} (4)

It should be noted that, ranking hotels by their reservation utility can imply how “desirable” these hotels can appear to consumer i. According to the “Selection rule”, consumer i searches sequentially and the results can be sorted from the hotel with the highest reservation utility, zi, rᵢ⁽¹⁾, to the lowest, zᵢᵣ, (j) in the ranking list. (See, e.g., Reference 45). Given the current best utility uᵢ*, the expected marginal benefits for consumer i from searching j can be, for example:

Bᵢⱼ(uᵢ*)=∫ᵢⱼ^{z}(uᵢⱼ−uᵢ*)f(uᵢⱼ)du ᵢⱼ. (5)

where f(·) can be the probability density function of hotel utility uᵢⱼ. The expected marginal benefits can represent the expectation of the utility for hotel j, given that it can be higher than uᵢ*, multiplied by the probability that uᵢ can exceed uᵢ*. The benefits of search may depend only on the distribution of utility above uᵢ*. Thus, the reservation utility zᵢⱼ can meet the following boundary condition, where the marginal search cost cᵢⱼ can equal the expected marginal benefits from searching hotel j, where, for example:)

cᵢⱼ=Bᵢⱼ(zᵢⱼ)=∫_{zij}^{z}(uᵢⱼ−zᵢⱼ)f(uᵢⱼ)duᵢⱼ. (6)

Thus, when consumer i's current best utility can be equal to the reservation utility of hotel j, uᵢ*=zᵢⱼ, the consumer can be indifferent between searching for j or stopping and accepting uᵢ*. Consumer i can continue to search for hotel j if the current best utility can be lower than the reservation utility of hotel j, uᵢ*<zᵢⱼ, and otherwise the consumer will stop

Exemplary Click Probability

The exemplary click probability can be defined. (See, e.g., Reference 30). r(j) can denote the hotel with the jth highest ranked reservation utility z_{i,r(j)}. π_{i,r(j)} can be the probability that consumer i will click hotel r(j). This probability can equal the probability that the current highest utility among all the previously “searched” j-1 hotels (e.g. those hotels that consumers either click or observe on the search result summary page) can be lower than the reservation utility of hotel r(j). Thus, the click probability of hotel r(j) for consumer i can be modeled as, for example:

$$\begin{matrix}{π}_{i , r ( j )} = Pr [ r ( j ) is clicked by consumer i ] \\ = Pr [ {{max}_{m = 1}}^{j - 1} ( {V}_{i , r ( m )} + {e}_{i , r ( m )} ) < {z}_{i , r ( j )} ] \\ = {\prod }_{m = 1}^{j - 1} {F}_{e} ( {z}_{i , r ( j )} - {V}_{i , r ( m )} ) , j > 1 ,\end{matrix} \qquad ( 7 )$$

where Fₑ(·) can be the CDF of eᵢⱼ, which can be eᵢⱼ·TypeI EV (0,1).

Exemplary Conditional Purchase Probability

Hotel r(j) can be purchased by consumer i if and only if consumer i stops searching and chooses r(j) over everything else within the choice set. Thus, the following two conditions can be met: 1) The utility of r(j) can be greater than the reservation utility of any other hotel that has not been searched for; and 2) The utility of r(j) can be greater than the utility of any other hotel that has already been searched for. S_{i,N}_{ᵢ} can be the search-generated optimal choice set of size Nᵢ for consumer i. Thus, the purchase probability of hotel r(j) for consumer i can be modeled as, for example:

$$\begin{matrix}{η}_{i , r ( j )} = Pr [ r ( j ) is purchased by consumer i ] \\ = Pr [ ( {V}_{ir ( j )} + {e}_{i , r ( j )} ) > {z}_{i , r ( m )} , r ( m ) ∉ {S}_{i , {N}_{i}} ] \times \\ Pr [ ( {V}_{ir ( j )} + {e}_{i , r ( j )} ) > ( {V}_{ir ( k )} + {e}_{i , r ( k )} ) , r ( k ) ∈ {S}_{i , {N}_{i}} ] \\ = {\prod }_{m = {N}_{i} + 1}^{J} ( 1 - {F}_{e} ( {z}_{i , r ( m )} - {V}_{i , r ( j )} ) ) \times \frac{exp ( {V}_{i , r ( j )} )}{1 + {\sum }_{k = 1}^{{N}_{i}} exp ( {V}_{i , r ( k )} )} .\end{matrix} \qquad ( 8 )$$

Exemplary Joint Probability of Click and Purchase (Probability of Search Path)

To model the probability of the consumer's full search path, most or all the previous click and purchase decisions by the consumer can be accounted for. In particular, the joint probability of all the click and purchase events in that consumer's search session can be examined. ω_{i,r(j),N}_{ᵢ} can be defined as the joint probability that consumer i has clicked Nᵢ hotels and then purchased hotel r(j). Thus, this joint (j) probability can be modeled as, for example:

$$\begin{matrix}{ω}_{i , r ( j ) , {N}_{i}} = Pr [ r ( 1 ) … r ( {N}_{i} ) are clicked by consumer i , \\ r ( j ) is purchased by consumer i , 0 \leq j \leq {N}_{i} ] \\ = ( {\prod }_{k = 1}^{{N}_{i}} {π}_{i , r ( k )} ) \times {η}_{i , r ( j )} .\end{matrix} \qquad ( 9 )$$

Exemplary Estimation

To model the utility of a hotel, X can be considered to contain most or all hotel characteristics that can be publicly available via the search engine, including (a) Hotel Class, (b) Hotel Brand, (c) Customer Rating and Total Review Count, (d) Amenity Count, (e) Number of Rooms, (f) Number of External Amenities, (g) Beach, (h) Lake, (i) Downtown, (j) Highway, (k) Public Transportation and (l) Crime Rate.

To analyze consumers' search costs, Q can be considered to contain different factors that can capture the structured and unstructured hotel information, as well as the online screen position of a hotel. For example, the design of the landing page for each hotel on Travelocity.com can be identical, each providing the same user interface, navigation, structure, hypertext links and website coherence, etc. Since a goal can be to examine consumer decisions based on the variation in the search costs, the variance in the amount and complexity of hotel-related information can be focused on. The Total Amenity Count can be used to approximate the structured hotel information. Regarding the unstructured hotel information, the Total Review Count, Review Readability (e.g., complexity, syllables and spelling errors) and Review Subjectivity (e.g., mean and standard deviation) can be used for approximation. In addition, the Page Number, Rank Order and Whether The Search Results Are Specially Sorted can be used in a particular consumer's search session (e.g., not under the default ranking) to capture the online position effect. Taking into consideration consumer heterogeneity, the search cost of consumer i for hotel j can be, for example:

$$\text{?} = exp ( {γ}_{0 i} + {γ}_{1 i} , {PAGE}_{j} + {γ}_{2 i} {RANK}_{j} + {γ}_{3 i} {SPECIALSORT}_{ij} + {γ}_{4 i} {AMENITYCNT}_{j} + {γ}_{5 i} {REVIEWCNT}_{j} + {γ}_{6 i} {COMPLEXITY}_{j} + {γ}_{7 i} {SYLLABLES}_{j} + {γ}_{8 i} {SPELLERR}_{j} + {γ}_{9 i} {SUB}_{j} + {γ}_{10 i} {SUBDEV}_{j} ) . \\ \text{?} \text{indicates text missing or illegible when filed} \qquad ( 10 )$$

Based on all the above, the overall likelihood function of each consumer searching for and purchasing each hotel can be derived as what can be observed from the data in, for example:

$$Likelihood ( θ ) = {\prod }_{i = 1}^{I} {\prod }_{j = 0}^{J} {( {ω}_{i , r ( j ) , {N}_{i}} )}^{{y}_{i}} , \qquad ( 11 )$$

where ω_{i,r(j),N}_{ᵢ} can be the joint probability of consumer click and purchase defined in Equation (9). I can be the total number of consumers and J can be the total number of hotels. yᵢ=1if the consumer has clicked and purchased hotel otherwise r(j); yᵢ=0. Correspondingly, the overall log-likelihood function can be, for example:

$$LL ( θ ) = {\prod }_{i = 1}^{I} {\prod }_{j = 0}^{J} [ {y}_{i} ln ( {ω}_{i , r ( j ) , {N}_{i}} ) ] . \qquad ( 12 )$$

Given the exemplary model setting, an exemplary goal can be to estimate the parameters of the random coefficients, which can be, for example:

$$\{ θ \} = \{ ( \overline{α} , {σ}_{α} ) , ( \overline{β} {,}_{β} ) , ( \text{?} ) , ( \text{?} ) \} . \\ \text{?} \text{indicates text missing or illegible when filed}$$

The exemplary model can be iteratively estimated using a Maximum Simulated Likelihood (“MSL”) method. In particular, the Monte Carlo method can be applied for numerical simulation, where for each individual observation, 250 random draws from the joint distribution of the individual heterogeneous parameters {θ} can be simulated and the corresponding individual-level joint probability ω_{i,r(j),N}_{ᵢ} can be computed. To maximize the log-likelihood function LL(θ), a non-derivative-based optimization procedure (e.g., the Nelder-Mead simplex method) can be chosen for heuristic search. This procedure can iteratively search for the optimal set of parameters {θ*} until the log-likelihood function can be maximized, for example:

$$\{ {θ}^{*} \} = {argmin}_{( {θ}^{*} )} {\prod }_{i = 1}^{I} {\prod }_{j = 0}^{J} [ {y}_{i} ln ( {ω}_{i , r ( j ) , {N}_{i}} ) ] . \qquad ( 13 )$$

Some of the computational complexity of the exemplary estimation can come from the calculation of the reservation values. During each iteration of the optimization procedure, each observation and each value of the search cost, zᵢⱼ=Bᵢⱼ⁻¹(cᵢⱼ) can be solved numerically. To improve the estimation efficiency, an interpolation-based method can be applied to compute the reservation values. (See, e.g., References 30, 31).

Exemplary Identification

It can be challenging to simultaneously identify consumers' heterogeneous preferences and search cost. A person can stop searching either because they have a high valuation for the products already found, or because they have a high search cost. Therefore, an observed search outcome can be explained either by the preferences for product characteristics or by the moments of the search cost distribution. (See, e.g., Reference 31). In the exemplary analytics, major effects that can be identified can include: (a) Consumer Preferences (e.g. Mean and Heterogeneity) and (b) Consumer Search Cost (e.g. Mean and Heterogeneity). An identification strategy of the exemplary system, method and computer-accessible medium can rely on the fact that consumer preferences may enter the decision-making processes of both search and purchase, whereas consumer search cost can enter only the search decision-making process. Once the consideration set can be generated after search, the conditional purchase decision may depend only on the consumer preferences. The exemplary unique dataset containing both consumer search data and purchase data facilitates the ability to identify these effects.

Exemplary Mean Consumer Preferences

The exemplary mean preferences for hotel characteristics can be identified by the correlation between the click and purchase frequencies of hotels, and the frequencies of the underlying hotels' characteristics. The mean effect of a hotel characteristic can be measured by how often the same, or similar, characteristic appears in the hotels that can be clicked or purchased by consumers. This identification can be similar to the identification in most traditional choice models, except that it can take into consideration not only the observed purchases, but also the clicks to infer consumer mean preferences.

Exemplary Heterogeneous Consumer Preferences

Exemplary consumer heterogeneous preferences can be identified from two perspectives. First, they can be partially identified from the search data based on the difference between the exemplary model's predicted click probabilities (e.g. based solely on the mean consumer preferences) and the observed click probabilities. Since consumers' final purchases can also be observed, this purchase data can facilitate the identification of the heterogeneous preferences based on the difference between the model's predicted purchase probabilities (e.g. based solely on the mean consumer preferences) and the observed purchase probabilities. The latter source can provide an opportunity to uniquely recover consumer heterogeneous preferences from the heterogeneous search cost because once the consideration set can be generated after search, the conditional purchase decision can depend only on consumer preferences.

Exemplary Mean Consumer Search Cost

The mean search cost can be partially identified by the observed average size of the consumer's search-generated consideration set. Note that the search cost can be modeled as a function of different characteristics, which can be viewed simply as additional hotel characteristics. Thus, similar to the identification of consumer mean preferences, the mean search cost coefficients can be identified based on the correlation between the observed click frequencies and the frequencies of underlying search cost characteristics.

Exemplary Heterogeneous Consumer Search Cost

The exemplary heterogeneous search cost can be identified through two sources. First, given that consumer heterogeneous preferences can be identified through the conditional purchase probabilities, the heterogeneous search cost can be identified by the joint variation of the consideration set size and the click probabilities. In addition, the nonlinear functional form in the reservation utility (e.g., Equation (6)) can also help identify consumer preference and search cost parameters. (See, e.g., Reference 30). Since the consumer preferences can enter the equation in a nonlinear manner (e.g., need to integrate over the utility), whereas the search cost enters the equation in a linear manner, this mathematical nonlinearity can help to separately identify consumer heterogeneous preferences and search cost.

Exemplary Empirical Results

Exemplary results can be shown in Table 3 column 2. First, it can be seen that the majority of the coefficients can be statistically significant at the p≦5% level, including both the mean effects ( α̅, β̅, γ̅) and the heterogeneity parameters(σ_{α}, Σ_{β}, Σ_{γ}). Consistent with theory, PRICE can have a negative effect on hotel demand. CLASS, AMENITYCNT, ROOMS, RATING and REVIEWCNT each can have a positive effect on hotel demand. For hotel location characteristics, it can be found that BEACH, TRANS, HIGHWAY, DOWNTOWN each can have a positive effect on hotel demand, whereas LAKE and CRIME each can show a negative effect. (See, e.g., Reference 18). Online screen position can have significant effects on consumer search cost. In particular, PAGE and RANK can both lead to an increase in the search cost.

Interestingly, it can be found that SPECIALSORT has a negative mean effect on consumer search cost, while also showing a large heterogeneity. This result can suggests that, on average, when consumers sort the search results by themselves using the ranking recommendation procedures provided by the product search engines, it helps them to reduce search costs by making the attractive products more visible. However, if the ranking is generally bad, or the top-ranked products are not satisfactory, such sorting action can have an opposite effect, and can lead to an increase in consumer search cost. This finding highlights the importance of search engine ranking design.

Both the seller-provided structured information and the social media-related unstructured information can lead to an increase in consumer search cost. AMENITYCNT and

REVIEWCNT can both show a positive sign, which can imply that the higher the number of hotel features, or greater the volume of reviews for a given hotel, the higher the cognitive costs for consumers to search and evaluate that hotel. The user review features such as COMPLEXITY, SYLLABLES and SPELLERR each can have a positive sign, suggesting that long and complex sentences, words with many syllables, or spelling errors in user reviews can discourage consumers from continuing to search on product search engines. Moreover, SUB and SUBDEV have a positive sign, implying that highly subjective and opinionated content that lacks objective information can create a cognitive burden for consumers during hotel search, and can lead to early termination of their search.

To determine the actual magnitude of the search cost, the dollar value of different search cost variables can be quantitatively derived. This dollar value can represent how much a certain variable effect can be translated into price. It can be found that, on average, the effort of continuing to search an additional page can cost $39.15, while the effort of continuing to search an additional screen position on the same page can cost $6.24. The exemplary findings are consistent with previous findings suggesting a non-trivial search cost in online markets. For example, a search cost of about $43.80 per page on a travel search engine has been found. Additionally, benefits from searching lower screens can equal about $6.55 for the median consumer. (See, e.g., References 7 and 31). Quantified rebidding costs can be about $4-$7.50 in a reverse auction channel. (See, e.g., Reference 21). Consumers' median search costs can be about $1.31-$2.90 for a sample of text books. (See, e.g., Reference 22). In addition, costs ranging from about $0.90 to about $1.80 per search in the online book industry have been found. (See, e.g., Reference 12).

A good ranking recommendation can, for example, on average, save consumers about $9.38. However, a bad ranking recommendation can lead to an about $18.54 loss for consumers. Meanwhile, a one-word increase in the average sentence length costs can increase consumer search cost by about $2.73. One more syllable, or one more spelling error per review, can cost consumers about $3.77 or about $1.60, respectively, during the product search. One more amenity displayed on the product search engine can increase search cost by about $1.00, and one more customer review can increase consumer search cost by about $1.17.

### Exemplary Model Prediction Experiments

Based on the model estimated coefficients from Table 3, a goal can be to predict the probability of the dynamic search path for an individual consumer on product search engines. If this probability can be predicted, the likelihood of the future actions for a given consumer at any stage of the search can be inferred. However, predicting all possible combinations of search paths can be computationally expensive. Instead, according to Equation (9) above, as long as the individual click probability and purchase probability can be predicted for each hotel, the overall probability of a particular search path can be dynamically derived. For better understanding, Example 2 can be seen below.

### EXAMPLE 2

Consider the same scenario described in Example 1. Based on the exemplary model estimates, it can be inferred, for a consumer like John or Mr. Smith, what the probability is for him to click or to purchase “Airport Inn” 120, “Best Western” 125 or “DoubleTree” 125, etc. For instance, suppose the probabilities for John to click “Airport Inn” 120, “Best Western” 125, “DoubleTree” 130, “Four Seasons” 135, and “Hilton” 140, have been computed to be 0.9, 0.7, 0.4, 0.1 and 0.4, respectively. His purchase probabilities towards these five hotels can be derived as, for example, 0.01, 0.02, 0.01, 0.02 and 0.2, and the probability for him to skip purchasing any hotel is 0.1.

Then, what John's next move would be at any stage of his search can be dynamically predicted. For instance, suppose he has already clicked “Airport Inn” 120, and “Best Western” 125. In this exemplary case, there are five possible options for his next move:
The probability to continue clicking “Four Seasons” 135 is about 0.9*0.7*0.4=0.252;
The probability to continue clicking “DoubleTree” 130 is about 0.9*0.7*0.1=0.063;
The probability to stop searching and purchase “Best Western” 125 is about 0.9*0.7*0.02=0.0126;
The probability to stop searching and purchase “Airport Inn” 120 is about 0.9*0.7*0.01=0.0063;
The probability to stop searching and purchase nothing is about 0.9*0.7*0.1=0.063.
   Therefore, given the highest predicted probability (e.g., about 0.252), he can be more likely to continue his search and click on the “Four Seasons” 135 listed on the search engine screen. Then, the probability of any search path prior to an actual search by a user can be derived. For example, the probability of John's full search path can be about 0.9*0.7*0.4*0.4*0.2=0.02016.

From the above example, it can be beneficial to predict the individual click probability and purchase probability for each hotel given a particular consumer. Once these two probabilities can be predicted, the overall probability of a search path at any stage of the search process can be dynamically derived. The prediction of the two individual probabilities can be achieved by substituting the model estimated coefficients into the Equations (7) and (8) above. To obtain individual-level consumer heterogeneity, an exemplary Monte Carlo simulation procedure can be applied. In particular, the same random draws that were simulated previously can be used from the joint distribution of the individual heterogeneous parameters. Then the corresponding individual click and purchase probabilities can be computed for each hotel given an individual consumer.

To examine the predictive performance of the exemplary model, a set of model prediction experiments can be conducted. The predicted individual click and purchase probabilities for each hotel can be computed as described above. Then, the predicted individual click and purchase probabilities can be compared with the observed click and purchase probabilities obtained from the exemplary data at the individual user session level. For model comparison, two baseline static demand estimation models can be estimated. The Mixed Logit model with full choice set and the Mixed Logit model with actual (e.g. limited) choice set. Both of them have been widely used for predicting consumer choice probabilities. The dataset can be randomly partitioned into two subsets: one with 70% of the total observations as the estimation sample and the other with 30% of the total observations as the holdout sample. To minimize any potential bias from the partition process, a 10-fold cross validation can be performed. Both in-sample and out-of-sample estimation can be conducted using the exemplary model and the two baseline models. The predictive performance of both the click and the purchase probabilities of a hotel can be compared. The prediction results for click probability are illustrated in columns 2-4 in Tables 5a and 5b. The prediction results for purchase probability are illustrated in columns 2-4 in Tables 6a and 6b.

The exemplary model prediction results can demonstrate that the exemplary model can outperform the two static baseline models in both in- and out-of-sample predictive power for both click and purchase predictions. For example, the in-sample results in Table 6a show that with respect to the root mean square error (“RMSE”), the exemplary system, method and computer-accessible medium can improve the prediction performance of purchase probability by about 34.89% as compared to the Mixed Logit model with full choice set, and can improve the model fit by about 17.30% as compared to the Mixed Logit model with limited choice set. Comparing the exemplary system, method and computer-accessible medium with another model in column 6, a 13.16% and a 22.02% increase show improvement in predictive power with respect to click-through and conversion probabilities, respectively. Similar trends in improvement in the predictive power occur with respect to the other two metrics, mean square error (“MSE”) and mean absolute deviation (“MAD”), in both in- and out-of-sample analyses. Overall, the exemplary system, method and computer-accessible medium, has the highest predictive power, followed by the Mixed Logit model with limited choice set. The Mixed Logit model with full choice set has the lowest predictive power.

Since the static models do not consider the search cost, it can be likely that the drop in predictive power can be caused by the missing variables that appear in the search cost from the search model. To examine this potential issue, two additional static models can be considered by incorporating all the search cost variables into the previous two Mixed Logit models. It can be found that although the model fit can increase for each static model, the overall performance can remain the highest for the exemplary system, method and computer-accessible medium. The corresponding results are illustrated in columns 5-6 in Tables 5a, 5b, 6a and 6b.

The model prediction experiments indicate that the exemplary system, method and computer-accessible medium can better predict the individual click and purchase probabilities for each product. Based on the derivation in Example 2, the overall probability for a certain search path can be computed according to Equation (9) above. Therefore, using the exemplary system, method and computer-accessible medium, search engines can more precisely predict consumers' online dynamic moves and prefetch the related web pages to minimize the response time.

### Exemplary Robustness Checks

To assess the robustness of the exemplary system, method and computer-accessible medium, and to analyze how social media and consumer heterogeneity (e.g., travel purposes and search engine ranking criteria) can affect the search cost and decisions of a consumer, three robustness tests can be conducted.

Exemplary Robustness Test I: Exclude the Social Media Variables from the Search Cost Specification

One of the important features of the exemplary system, method and computer-accessible medium, according to an exemplary embodiment of the present disclosure, can be to examine how the amount and complexity of product-related social media content can affect consumer search cost. Therefore, it can be beneficial to compare the differences in the search models with and without the set of social media variables. The results of this test are illustrated in Table 3, column 3. First, it can be seen that that the estimated coefficients can be qualitatively consistent with the main results. It can also be seen that the model that does not account for social media cognitive variables presents a significantly higher magnitude in both the mean effect and the heterogeneity from price (e.g. 1.917 vs. 1.406 and 0.735 vs. 0.427). This result can indicate that consumers' cognitive costs to digest social media content during online product search can be non-negligible. Failing to account for such costs can lead to an overestimation of price sensitivity in the online search market.

Exemplary Robustness Test II: Use an Alternative Static Model with Actual (e.g. Limited) Choice Set

To examine the potential bias from the endogenous and limited nature of search-generated choice sets, a model can be considered that can be widely used in the static demand estimation: the Mixed Logit model. (See, e.g., Reference 34). To account for the variation in choice sets, the consumer decision process can be modeled under the actual searched (e.g. limited) choice set, rather than under the universal choice set available in the market. Note that the major difference between a static Mixed Logit model with actual choice sets and the exemplary system, method and computer-accessible medium can be that the exemplary system, method and computer-accessible medium can capture not only the limited nature of the choice sets, but also the dynamic and endogenous formation process of the choice sets. A static model can typically take the choice set as exogenously given.

For example, using a static model without accounting for consumers' dynamic search behavior can lead to an overestimation of the price elasticity coefficient. The interpretation of this finding can be attributed to the nature of the hotel search market. An exemplary model that can capture consumers' actual search behaviors can find lower price sensitivity, implying that consumers in the hotel search market tend to highly evaluate the quality of hotels and put weight on non-price factors during search (e.g., class, amenities or reviews). The exemplary finding on price sensitivity can be consistent with prior findings. (See, e.g., References 7 and 31). Both studies can illustrate that when consumers face a highly differentiated market (e.g., product differentiation or retailer differentiation), they can be more likely to focus on non-price factors during their search. Therefore, the estimated price elasticity can be lower when incorporating consumers' search behaviors into the model. In contrast, when a market can be less differentiated, consumers can become more price-sensitive and tend to focus on price search. Thus, a search model that incorporates consumers' search behaviors can find a higher price elasticity of demand than a static model does. (See, e.g., Reference 13). The results of this robustness test are shown in Table 3, column 4.

Exemplary Robustness Test III: Interaction Effects between Consumer Travel Purposes and Sorting Methods

One of the advantages of the exemplary system, method and computer-accessible medium model can be that it can account for consumer heterogeneity during the search process. Under the context of hotel search, it can be beneficial to understand how certain variation in the search cost can be explained by consumers' choices of different sorting methods under heterogeneous travel purposes. To do so, the interaction effects between consumer travel purposes and sorting criteria on search cost can be examined.

First, to capture consumers' heterogeneous travel purposes, Tᵢ can be defined as an indicator vector with identity components representing the travel purpose, for example:

Tᵢ′=[Familyᵢ Businessᵢ Romanceᵢ Touristᵢ Kidsᵢ Seniorᵢ Petsᵢ Disabilityᵢ]_{1,g}. (14.1)

The empirical distribution of Tᵢ can be acquired from online consumer reviews and reviewers' profiles.

Second, to capture the effects from different sorting methods, the scalar dummy variable SPECIALSORT can be broken down into an indicator vector with identity components representing the use of different sorting methods. In particular, six different sorting criteria that consumers use during their searches can be observed: (1) default (“DFT”), (2) price ascending (“PRA”), (3) class descending (“CLD”), (4) class ascending (“CLA”), (5) city name ascending (“CAN”) and (6) hotel name ascending (“HNA”). Sᵤ can denote the indicator vector of sorting method under which product j can be presented to consumer i during his/her search, for example:

S_{if}′=[DFTᵢⱼ PRAᵢⱼ CLDᵢⱼ CLAᵢⱼ CNAᵢⱼ HNAᵢⱼ]_{1×6} (14.2)

Thus, the basic model of search cost can be extended to, for example:

cᵢⱼ=exp(γ_{i,t}−γ_{1f}PAGEⱼ+γ_{2f}RANKⱼ+τTᵢ×Sᵢⱼ+γ_{4f}AMENITYCNTⱼ+γ_{5f}REVIESWCNTⱼ+γ_{6f}COMPLEXITYⱼγ_{7f}SYLLABLESⱼ+γ_{8f}SPELLERRⱼ+γ_{9f}SUB_{f}+γ_{10f}SUBDEVⱼ). (15)

where everything else can remain the same as that in Equation (10), except that τ can be an 8×6 matrix of coefficients that can measure how consumers' taste parameters vary with different travel purposes and choices of sorting criteria. The estimation results of interaction effects are illustrated in Table 4.

Consumers' travel purposes can explain their heterogeneous search costs under different ranking mechanisms. In general, DFT can reduce search costs for different consumers. This reduction can appear to be the largest for consumers who plan to travel with their families (e.g., about −2.452), followed by business travelers (e.g., about −1.757), romance travelers (e.g., about −1.289) and tourists (e.g., about −0.836). However, there may not be significant interaction effects for consumers who travel with young kids, senior citizens or families with pets. This finding can indicate that the current default ranking captures mainly consumers' preferences under the most popular travel contexts. The default ranking may not be the most effective when consumers are searching for certain special amenities during travel search.

The PRA can decrease the search costs for tourists (e.g., about −1.869), family travelers (e.g., about −1.007) and senior citizens (e.g., about −0.537), while it can increase the search costs for romance travelers (e.g., about 1.203) and business travelers (e.g., about 0.989). This can suggest that romance and business travelers can be less price-sensitive, whereas tourists can be the most price-sensitive. Ranking by hotel class does not seem to reduce consumers' search costs. In fact, CLD can lead to a significant increase in the search costs for business travelers (e.g., about 1.073), family travelers (e.g., about 0.780) and travelers with young kids (e.g., about 0.204). Meanwhile, CLA can lead to a significant increase in the search costs for romance travelers (e.g., about 3.030) and family travelers (e.g., about 1.291). This can suggest that starting with similar hotels (e.g. either the luxury ones or the budget ones) may not be informative for consumers during the search. Consumers may be willing to explore products with better variety (see, e.g., Reference 18), especially when they face certain constraints and cannot search exhaustively. HNA can significantly reduce search costs for different categories of travelers. Under this ranking mechanism, search costs can decrease the most for business travelers (e.g., about −2.076), followed by senior citizens (e.g., about −0.701) and romance travelers (e.g., about −0.417). This can indicate that hotel brands can significantly reduce consumers' search costs under certain travel contexts. For example, business travelers going to attend a conference can seek particular hotels that can be recommended by the conference. Seniors travelers can prefer special hotel chains reputed for being friendly to them and look for them directly.

The exemplary system, method and computer-accessible medium, according to an exemplary embodiment of the present disclosure, can examine a travel search engine context, looking specifically at consumer selection of a hotel. Archival data analysis can be applied to gain insights into the product rating effects and ranking effects on consumers' click and purchase behaviors. Using a panel data set from November 2008 to January 2009, containing approximately one million online user search sessions—including detailed information on consumer searches, clicks, and transactions obtained from Travelocity—a hierarchical Bayesian framework can be utilized in which a simultaneous equation model can be built to jointly examine the interrelationship between consumers' click and purchase behavior, search engine ranking decisions, and customers' ratings.

The variation in the ratings of different hotels can be examined (e.g. both hotel “class” rating and customer rating) at the same rank on the travel search engine over time. In addition, the exemplary data setting can vary in rank of the same hotel, over time, because the same hotel can appear at different positions at different points in time. Controlling for room prices, such variation can facilitate the ability to model the interaction effect of hotel class and customer ratings with rank, and to measure its effect on demand.

How different ranking mechanisms can affect the search engine revenue can be examined. This can be achieved by conducting a set of policy experiments. Six different ranking designs can be considered: (1) utility-based, (2) CR-based, (3) CTR-based, (4) price-based, (5) customer rating-based and (6) Travelocity default procedures. The exemplary model can be estimated, and future search engine revenues can be predicted under each ranking mechanism.

How different levels of personalized ranking mechanisms can affect consumer behavior and search engine revenue can be examined. Particularly, two types of personalization mechanisms used to drive the ranking of results in response to a query can be examined: (1) active personalized ranking, and (2) passive personalized ranking A ranking system that can facilitate consumers to proactively interact with the recommendation procedure prior to the display of results from a search query can be classified as “active.” By contrast, a ranking system that does not facilitate customers to interact with the recommendation procedure can be classified as “passive.”

It is believed that presently, no hotel search engine has explicitly adopted a personalization-based approach to hotel ranking because the engines still grapple with the issue of whether such an approach can be useful. Therefore, no archival data in any product search engines have information on the effect of personalized ranking on user behavior. Thus, randomized experiments can be utilized using a hotel search engine application. The exemplary randomized experimental results were based on a total of 900 unique user responses over a two-week period via the AMT crowd-sourcing platform. A customized behavior-tracking system was used to observe the detailed information of consumers' search, evaluation, and purchase decision-making process. By manipulating the default ranking method and by enabling or disabling a variety of personalization features on the hotel search engine website, the effect of personalized ranking on consumer behavior was studied.

The exemplary archival data analysis and randomized experiments are consistent in demonstrating the following: (1) A utility-based ranking mechanism can lead to a significant increase in the overall search engine revenue; (2) significant interplay can occur between search engine ranking and product ratings. An inferior rank can affect “higher-class” hotels more adversely. On the other hand, hotels with a lower customer rating can be more likely to benefit from being placed on the top of the screen. These findings can illustrate that product search engines could benefit from directly incorporating signals from online social media into the ranking procedures; and (3) the exemplary randomized experiments can also reveal that an active personalized ranking mechanism that enables consumers to specify both search context and individual preferences can lead to more clicks, but lower purchase propensities and lower search engine revenue, as compared to passive personalized ranking mechanisms. A plausible explanation can be related to theories of consumer cognitive cost. Prior theoretical work has shown that information overload and non-negligible search costs can discourage decision makers from evaluating choices, leading to a scenario where they make no choices at all. The exemplary empirical finding can dovetail with previously known theoretical conclusions where providing more information can actually lead to fewer purchases. (See, e.g., Reference 60). It can also be consistent with previously known models that can show that consumers who do not have well-formed preferences at the start of their search can be better off with uncertainty about product attribute levels rather than having perfect knowledge of the attributes of all available products. (See, e.g., Reference 58). Therefore, although an active personalized ranking recommendation can help consumers discover what they want to buy, product search engines should not ubiquitously adopt it.

An “online session” can be defined to capture a set of activities by an online user identified by a unique cookie. In the exemplary data above, a starting indicator and an ending indicator with a corresponding time stamp (e.g., provided by the company) can characterize each unique online session. More specifically, a typical online session can involve the initialization of the session, the search query, the results (e.g., in a particular rank order) returned from that search query, the sorting method, the click(s) on hotel(s) if any exist, the login and actual transaction(s) if any conversion occurs and the termination of the session. The ending indicator can mark the termination of a session.

A “display” for a hotel can be counted if that hotel appears visible to a consumer on the web page in an online search session. Meanwhile, a “click” can be counted if a consumer selects the hotel, and a “conversion” can be counted if a consumer has completed the payment in that online session. Sessions with at least one display can be considered. A display can lead to a click, but it may not lead to a purchase. Each hotel that counts for a display can be associated with a page number and a screen position, which can capture the corresponding page order (e.g., within-page) and rank order of that hotel in the search results. When Travelocity displays the hotel search results on a web page, it only shows 25 hotels per page. This design can restrict the rank order for each hotel within the range from 1 to 25. Meanwhile, to facilitate consumer search, Travelocity provides a sorting criterion called “Travelocity Pick” by default. It also provides multiple alternative sorting criteria: Price, Hotel Class, Hotel Name and Customer Review Rating.

Each observation in the exemplary dataset can contain the hotel id, week id, number of competing hotels, number of displays, number of clicks, number of conversions, average screen position (e.g., rank on the result page), average page number and the corresponding hotel characteristics in that week. For a better understanding of the variables in the exemplary setting, the definitions and the summary statistics of the exemplary data variables is shown in Table 7.

### Exemplary Further Empirical Model

The exemplary system, method and computer accessible medium, according to an exemplary embodiment of the present disclosure, can utilize simultaneous equation models of click-throughs, conversions, and ranks The exemplary click-through and conversion behavior can be modeled as a function of hotel brand, price, rank, page, sorting criteria, and hotel characteristics (e.g., which can be available from either the hotel search summary page or the hotel landing page, depending on the stage in a search process). The rank of a hotel can be modeled as a function of hotel brand, price, sorting criteria, hotel characteristics that can be available from the hotel landing page, and performance metrics such as previous conversion rate. Each function can contain an unobserved error that can normally be distributed with mean zero. To capture the unobserved co-variation among clickthroughs, conversions, and rank, three error terms can be assumed to correlate, and multivariate normal distribution with mean zero can be followed.

### Exemplary Further Model Setup

As an initial matter, for example, a unit of observation to be “hotel-week” can be defined. Thus, for hotel j in week t, nⱼₜ can be used to denote the clickthroughs among Nⱼₜ displays (e.g., nⱼₜ≦Nⱼₜ and Nⱼₜ>0). mⱼₜ can denote the conversions among the nⱼₜ clickthroughs (e.g., mⱼₜ≦nⱼₜ). pⱼₜ can denote the probability of having a click-through can denote qⱼₜ the probability of having a conversion conditional on a click-through. The consumer decision process can involve two steps. In the first step, the consumer can see a hotel displayed on the search result web page and decide whether or not to click on it. In the second step, if the consumer clicks on the hotel, the consumer can decide whether or not to purchase it. Accordingly, three types of events can be observed:

A consumer sees a hotel, but does not click or purchase. The probability of such an event can be 1−pⱼₜ. A consumer sees a hotel, clicks through, but does not purchase. The probability of such an event can be pⱼₜ (1−qⱼₜ). A consumer sees a hotel, clicks through, and makes a purchase. The probability of such an event can be pⱼₜqⱼₜ. Therefore, the probability of observing the joint occurrence nⱼₜ of click-throughs and mⱼₜ conversions, (e.g., nⱼₜ, mⱼₜ) can be calculated to be, for example:

$$Pr ( {n}_{jt} , {m}_{jt} \vert {p}_{jt} , {q}_{jt} ) = {C}_{{N}_{jt}}^{{n}_{jt}} \cdot {( {p}_{jt} )}^{{n}_{jt}} \cdot {( 1 - {p}_{jt} )}^{{N}_{jt} - {n}_{jt}} \cdot {C}_{{n}_{jt}}^{{m}_{jt}} \cdot {( {q}_{jt} )}^{{m}_{jt}} \cdot {( 1 - {q}_{jt} )}^{{n}_{jt} - {m}_{jt}} = \frac{{N}_{jt} !}{{m}_{jt} ! ( {n}_{jt} - {m}_{jt} ) ! ( {N}_{jt} - {n}_{jt} ) !} \cdot {( {p}_{jt} {q}_{jt} )}^{{m}_{jt}} \cdot {[ {p}_{jt} ( 1 - {q}_{jt} ) ]}^{{n}_{jt} - {m}_{jt}} \cdot {( 1 - {p}_{jt} )}^{{N}_{jt} - {n}_{jt}} . \qquad ( 16 )$$

### Exemplary Simultaneous Equation Model of Clickthrough, Conversion, Rank, and Rating

The click-through, conversion, rank and customer rating can be modeled simultaneously in a hierarchical Bayesian framework. In particular, the exemplary model can be divided into four interactive components.

### Exemplary Clickthrough Rate Model

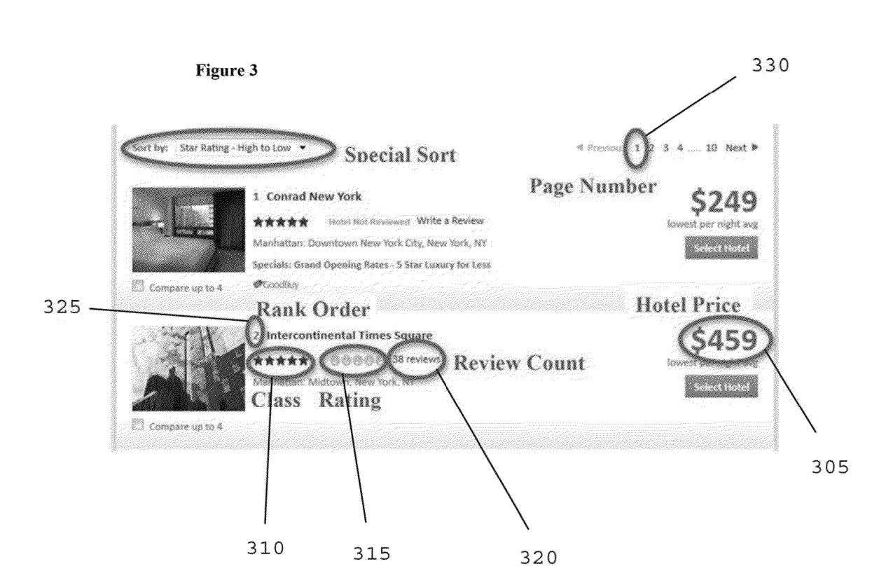

First, a consumer's decision to click on a hotel can be based on the information available on the Travelocity search results page. FIG. 3 illustrates an exemplary screen shot of a sample web page of hotel search results on Travelocity. As denoted in FIG. 3, information that enters the consumer decision-making process can include hotel price 305, hotel class 310, reviewer rating 315, review count 320, rank order 325 and page number 330. Prior literature has shown that rank order 325 and page number 330 can be a significant determinant of clicks on the results of a search engine query. (See, e.g., References 19, 59, 70 and 71). In addition, previous studies have found that rank can have a significant and non-linear effect in the context of keyword advertising. (See, e.g., References 1 and 19). To account for the potential non-linear ranking effect in hotel search, an additional quadratic term of rank in the model can be considered. Recent theoretical work has shown that product price can affect consumer actions such as click and conversions and search engine decision. (See, e.g., References 55, 56 and 73). Additionally, user ratings can affect click-through rates on search engines.

Based on the above, the volume and valence of reviews can be incorporated. Recent studies have also shown that online search refinement tools, such as the sorting selection menu, can affect consumers' searches and intentions to purchase. (See, e.g., Reference 10). Therefore, to capture the effect associated with the search refinement tools and to control for consumers' particular sorting preferences, the vector SpecialSortⱼₜ can be included that can contain six control variables to capture the frequency of six sorting criteria that consumers can use during the search process for hotel j in week t. Moreover, previous research has shown that product brand can influence consumers' perceptions of quality and willingness to buy. (See, e.g., References 57, 66). Thus, hotel brand dummies can be included to control for the unobserved hotel characteristics. Finally, prior literature has demonstrated that the number of competitors in the local market can affect consumers' clicks for a product online (See, e.g., Reference 3). Therefore, to control for the competition in the local market, the total number of hotels in j's city, Hⱼ, can be included as a control variable. This setting can give the following equation:

$${p}_{jt} = \frac{exp ( {U}_{jt}^{p} )}{1 + exp ( {U}_{jt}^{p} )} \\ where , \\ {U}_{jt}^{p} = {β}_{j 0} + {β}_{j 1} {Rank}_{jt} + {β}_{j 2} {Rank}_{jt}^{2} + {β}_{j 3} {Page}_{jt} + {β}_{j 4} {Price}_{jt} + {β}_{j 5} {Rating}_{jt} + {β}_{j 6} {ReviewCount}_{jt} + {α}_{1} {Class}_{j} + {α}_{2} {H}_{j} + {α}_{3} {Brand}_{j} + {α}_{4} {SpecialSort}_{jt} + {ɛ}_{jt} . \qquad ( 17 )$$

To capture the unobserved heterogeneity, a can be modeled, the intercept and the coefficients for the time-varying variables can be modeled to be random coefficients, for example:

$$β = [ \begin{matrix}{\overline{β}}_{j 0} \\ … \\ {\overline{β}}_{j 6}\end{matrix} ] + {Π}^{β} {D}_{j} + [ \begin{matrix}{σ}_{j 0}^{β} \\ … \\ {σ}_{j 6}^{β}\end{matrix} ] , \qquad ( 18 )$$

where each random coefficient can be assumed to vary along its population mean and the hotel-specific characteristics. More specifically, Dⱼ can be a d×1 vector of observed hotel-specific characteristics. According to the exemplary system, method and computer-accessible medium, three time-invariant variables can be considered that can capture the hotel quality: (1) hotel class, (2) average hotel price and (3) average reviewer rating (e.g., d=3). π^{β} can be a Z×d matrix of coefficients that can measure how hotel utility can vary with observed hotel characteristics (e.g., Z=7 can be the dimension of vector β). Moreover, the unobserved error terms to be correlated can be modeled by, for example:

[σⱼ₀^{β}, . . . σⱼ₆^{β}]′˜MVN(0, Σ^{β}), where Σ^{β} is a 7×7 covariance matrix. (19)

### Exemplary Conversion Rate Model

The set of features shown in FIG. 3 can be a key determinant for a consumer's purchase decision making as well. Moreover, prior work has shown that price and quality, as well as the volume and valence of online reviews, can affect product sales. (See, e.g., References 18 and 52). Meanwhile, several studies have shown how screen position and page number can be important factors that can influence consumer demand on search engines. (See, e.g., References 1, 19, 70 and 71). Thus the probability of a consumer's conversion can be modeled as a function of the set of hotel price-, quality-, review- and screen position-related factors: hotel price, hotel class, reviewer rating, review count, rank order and page number. To account for the non-linear effect of ranking effect, the quadratic term of rank order can be included. Based on the previous findings that market competition (see, e.g., Reference 3), product brand (see, e.g., References 57 and 66) and online consumer search refinement tools (see, e.g., Reference 10) can be key determinants of the elasticities of demand, the total number of hotels, brand, and special sort can be included as additional control variables. The conversion equation can be written, for example, as:

$${q}_{jt} = \frac{exp ( {U}_{jt}^{q} )}{1 + exp ( {U}_{jt}^{q} )} , \\ where \\ {U}_{jt}^{q} = {γ}_{j 0} + {γ}_{j 1} {Rank}_{jt} + {γ}_{j 2} {Rank}_{jt}^{2} + {γ}_{j 3} {Page}_{jt} + {γ}_{j 4} {Price}_{jt} + {γ}_{j 5} {Rating}_{jt} + {γ}_{j 6} {ReviewCount}_{jt} + {θ}_{1} {Class}_{j} + {θ}_{2} {H}_{j} + {θ}_{3} {Brand}_{j} + {θ}_{4} {SpecialSort}_{jt} + {η}_{jt} . \qquad ( 20 )$$

Similar to Equation (18), γ can be modeled as random coefficients with the following exemplary properties:

$$γ = [ \begin{matrix}{\overline{γ}}_{j 0} \\ … \\ {\overline{γ}}_{j 6}\end{matrix} ] + {Π}^{γ} {D}_{j} + [ \begin{matrix}{σ}_{j 0}^{γ} \\ … \\ {σ}_{j 6}^{γ}\end{matrix} ] . \qquad ( 21 )$$

Dⱼ can also contain hotel class, average hotel price and average reviewer rating. Moreover, the unobserved error terms in equation (21) can be modeled to be correlated in the following exemplary manner:

[σⱼ₀^{γ}, . . . , σⱼ₆^{γ}]′˜MVN (0, Σ^{γ}), where Σ^{γ} is a 7×7 covariance matrix. (22)

### Exemplary Ranking Model

Equations (17) through (22) can model consumers' behavior of click-through and conversion. Additionally, a search engines' ranking decision can be modeled. Prior research in keyword search advertising has found that both the bid price and the quality of the keyword can affect ranking (See, e.g., Reference 19). Building on the previous findings, along with further interaction with Travelocity, the rank order of hotel j in week t can be modeled as being dependent on the set of hotel price and quality characteristics. In particular, the previous conversion rate, CR_{j,t-1} can be used as a quality performance metric. The same set of control variables can be considered as used in the previous consumer behavior models. The model can be written as, for example:

ln(Rankⱼₜ)=ωⱼ₀+ωⱼₜCR_{j,t-1}+ωⱼ₂Priceⱼₜ+ωⱼ₃Ratingⱼₜ+ωⱼ₄ReviewCountⱼₜ (23)

Similarly, ù can be modeled as random coefficients to vary along the population mean and the hotel-specific characteristics Dj, which can contain hotel class, average hotel price, and average reviewer rating where, for example:

$$ω = [ \begin{matrix}{\overline{ω}}_{j 0} \\ … \\ {\overline{ω}}_{j 4}\end{matrix} ] + {Π}^{ω} {D}_{j} + [ \begin{matrix}{σ}_{j 0}^{ω} \\ … \\ {σ}_{j 4}^{ω}\end{matrix} ] . \qquad ( 24 )$$

Additionally, the unobserved error terms in equation (24) to be correlated can be modeled, for example:

[σⱼ₀^{ω}, . . . , σⱼ₄^{ω}]′˜MVN(0, Σ^{ω}), where Σ^{ω} is a 5×5 covariance matrix. (25)

### Exemplary Rating Model

Customer ratings on product search engines can be endogenous, and can often be determined by many hotel-specific characteristics, such as price, class, brand, etc. To account for the endogeneity of rating, it can be modeled as the fourth dependent variable in the simultaneous framework. Prior work has shown that product price and product quality can affect customer ratings. (See, e.g., Reference 62). Therefore, the customer rating of hotel j in week t can be modeled as being dependent on the set of hotel price and quality-related characteristics. Additionally, the screen position and sorting method of the hotel can be included in the last period to control for the visibility of the hotel. The hotel brand and the total number of hotels in the local market can also be controlled for by, for example:

Ratingⱼₜ=ρⱼ₀+ρⱼₜRank_{j,t-1}+ρⱼ₂Rank_{j,t-1}²+ρⱼ₃Page_{j,t-1}+ρⱼ₄Priceⱼₜ+ρⱼ₅ReviewCountⱼₜ+χ₁Classⱼ+χ₂Hⱼ+χ₃Brandⱼ+χ₄SpecialSort_{j,t-1}+ψⱼₜ. (26)

where ρ can be modeled as random coefficients to vary along the population mean and the hotel-specific characteristics Dⱼ. In the rating model, Dⱼ can be considered to contain hotel class and average hotel price where, for example:

$$ρ = [ \begin{matrix}{ρ}_{j 0} \\ … \\ {ρ}_{j 5}\end{matrix} ] + {Π}^{ρ} {D}_{j} + [ \begin{matrix}{σ}_{j 0}^{ρ} \\ … \\ {σ}_{j 5}^{ρ}\end{matrix} ] . \qquad ( 27 )$$

The unobserved error terms in equation (27) can be modeled to be correlated in a similar fashion, where, for example:

[σⱼ₀^{ρ}, . . . , σⱼ₅^{ρ}]′˜MVN(0, Σ^{ρ}), where Σ^{ρ} is a 6×6 covariance matrix. (28)

To capture the unobserved co-variation and the potential endogenous relationship among click-through, conversion, rank, and rating, the four error terms in equations (17), (20), (23) and (26) can be assumed to be correlated as, for example:

[εⱼₜ, ηⱼₜ, υⱼₜ, ψⱼₜ]′˜MVN(0, Ωⱼₜ), where Ωⱼₜ is a 4×4 covariance matrix. (29)

### Exemplary Empirical Analyses and Results

To estimate the exemplary model, the Markov Chain Monte Carlo (“MCMC”) methods using a Metropolis-Hastings procedure with a random walk chain can be applied. (See, e.g., Reference 53). In particular, the MCMC chain can be run at about 80,000 iterations, and the last about 40,000 iterations can be used to compute the mean and standard deviation of the posterior distribution of the model parameters.

### Exemplary Clickthrough Rate Model Results

The results of the click-through model can be seen in Table 8a. All or most of the exemplary coefficients can be statistically significant at the 5% level. The coefficients of both Rank and Page can be negative and statistically significant, confirming that a position effect does exist. A hotel that appears on an earlier page in the search results, or on a higher position on the screen, can receive more clicks than a hotel that appears on a latter page or on a lower position. A one-position increase in rank can lead to an about 10.07% increase in click-throughs on average. Moreover, a positive coefficient can be found on the quadratic term of rank, suggesting the negative effect of rank on CTR increases at a decreasing rate. Consistent with theory and existing empirical findings (see, e.g., Reference 3), Price can have a negative sign. Thus, showing the higher the price of a hotel, correlates to the lower the willingness of consumers to click on that hotel. Class can have a positive sign, showing the higher the hotel class, the lower the CTR.

The interaction effect between Rank and Class can be negative, and statistically significant (e.g., about −0.026). The interaction effect between Rank and Price can also be statistically significantly and negative (e.g., about −0.019). However, the interaction effect between Rank and Rating can be statistically significant and positive (e.g., about 0.020). These findings, as described above, can indicate that higher-class or more expensive hotels can be more sensitive to the online ranking effect; they tend to be more adversely affected by an inferior screen position as well (e.g., at the lower part of the screen). On the other hand, hotels with lower online user ratings can be more likely to benefit from being placed on the top of the search results, an effect that also benefits the underlying search engine that can typically be paid by click-through or conversion. This finding can also illustrate the need for product search engines to directly incorporate signals from online social media into the ranking procedures.

### Exemplary Conversion Rate Model (Cont.)

The exemplary coefficient estimates from the exemplary conversion model are presented in Table 8b. Most of the coefficients can be statistically significant at the 5% level. Rank and Page can have a negative and statistically significant effect, indicating that screen position may not only affect click-throughs, but can also significantly affects conversion. Consumers can be more likely to book a hotel that can be positioned on an earlier page in the search results and at the top of a web page. In particular, a one-position increase in rank can correspond to an about 5.63% increase in conversions on an average. Similarly, a positive coefficient can be found on the quadratic term of rank, suggesting the negative effect of rank order on conversion rate also increases at a decreasing rate.

As expected, price can have a negative effect on hotel demand, whereas Class can have a positive effect on hotel demand. The online word-of-mouth-related variables, Rating and Review Count, can have a statistically significant and positive effect on hotel demand. Similar trends were also found in the interaction effects between Ranking and Price/Class/Rating, suggesting hotels with a higher class and more expensive hotels can be more sensitive to the online ranking effect. Further, hotels that receive lower ratings from users can benefit more when placed on the top of the screen. The total number of hotels in a certain market, H, can have a negative effect on hotel-level conversion rate. Indeed, the higher the number of choices available to consumers, the lower the probability of buying from any given hotel. Thus, on average, the conversion rate for each hotel decreases.

### Exemplary Ranking Model

The coefficient estimates from the exemplary ranking model are presented in Table 8c. This sheds light on how search engines' ranking decisions can be related to different product inherent characteristics, social media influences, and certain performance metrics such as previous conversions. Price can be found to have a positive sign and Class can have a negative sign. All else being equal, a hotel with a higher price can be more likely to appear in a better screen position. A higher-class hotel can be more likely to appear in a higher screen position, after controlling for the sorting criteria. Both Rating and Review Count can have a significant and negative effect, indicating that hotels with a higher user rating and with more reviews can be more likely to appear at the top of a page, controlling for all other factors.

### Exemplary Rating Model (Cont.)

The exemplary coefficient estimates from the exemplary rating model are shown in Table 8d. The exemplary rating model facilitates the ability to account for the potential endogenous nature of the customer ratings. It can be found that both Rank and Page can have a negative and statistically significant effect, suggesting screen position can also be correlated with a hotel's rating. Hotels with higher ratings can be more likely to be positioned on an earlier page in the search results and at the top of a web page. It can also be found to have a similar positive effect from the quadratic term of rank, which suggests the marginal effect of ranking on rating can be decreasing.

In the exemplary model, consumer evaluation (e.g., rating of a hotel, utility of clicking, or booking a hotel) can be assumed to be a quadratic function of the rank order. As a robustness check, a simple linear form can also be used. The quadratic term of the rank order can be excluded from the click-through, conversion, and rating models. The qualitative nature of the estimation results can remain consistent.

### Exemplary Policy Experiment: Effect of Ranking on Revenue

Previous work has shown that a consumer utility-based search engine ranking system can lead to an increase in consumer surplus. (See, e.g., Reference 18). However, how such a ranking system affects the search engine's revenues can be unclear. Therefore, one question of interest can be how different ranking mechanisms would affect search engine revenues.

Based on the six policy experiments above, for the consumer-utility-based ranking, the ranking equation can be calculated based on equation (8). For the other five ranking designs, the ranking equation can be defined to contain only the corresponding variable on the right-hand side. For example, in the case of the price-based ranking mechanism, the ranking equation can be defined to contain the price variable as the independent variable. All other control variables can remain the same in each of the six scenarios.

The exemplary simultaneous equation model can be estimated under each different ranking equation using data from the previous t-1 periods. Based on the estimates, the CTR and CR can correspondingly be predicted for the t-th period under each case. This process can facilitate the ability to predict the future revenue for the search engine under various ranking mechanisms. The overall revenue for the search engine can be, for example:

$$Revenue = {\sum }_{j = 1}^{J} ( {CR}_{j} * {CTR}_{j} * {Price}_{j} ) . \qquad ( 30 )$$

From the exemplary prediction results it can be found that although the Travelocity default ranking and price-based ranking mechanisms can lead to higher search engine revenue received from the top-ranked hotel, the consumer-utility based ranking mechanism can lead to the highest overall revenue received from all hotels. This finding can suggest that a utility-based ranking mechanism may not only maximizes the surplus for consumers (see, e.g., Reference 18), but can also maximize the revenue for search engines.

The above can be due to the diversity provided in the utility-based ranking Consistent with the previous results (see, e.g., Reference 18), consumers can prefer the diversity in the ranking results. Additionally, under the utility-based ranking mechanism, consumers can be more likely to click and purchase products that can be ranked lower in the list, compared to all the other competing ranking mechanisms. This finding can explain why the utility-based ranking outperforms the others (e.g. especially the price-based or short-term revenue-based mechanisms) in the overall search engine revenue. The additional conversions received from the lower-ranked products can dominate the overall compromise in price. A detailed prediction result is shown in Table 10.

### Exemplary Randomized Experimental Design

The exemplary Bayesian analysis provides important insights into the relationship between search engine ranking mechanism and consumer behavior. However, to fully understand how consumers make decisions in the product search engine context, randomized experiments can be designed and conducted. Specifically, the effectiveness of four ranking mechanisms and two personalization designs, active (e.g. customizable) personalized ranking and passive (e.g. non-customizable) personalized ranking, on influencing consumer behavior and search engine revenues, can be tested.

In a randomized experiment, a study sample can be divided into two groups: one receiving the intervention being studied (e.g. the treatment group) and the other not receiving it (e.g. the control group). Randomized experiments have major advantages over observational studies in making causal inferences. Randomization of subjects to different treatment conditions can ensure the treatment groups are, on average, identical with respect to all possible characteristics of the subjects, regardless of whether those characteristics can be measured. In one experiment, four treatment groups can be designed. Each group can be exposed to the same search-ranking mechanism except for a different default ranking method. In the second experiment, there can be two treatment groups and one control group. The control group can be granted full access to the search mechanism with active personalization that facilitates them to interact with and customize the search engine recommendation procedure. By contrast, the two key personalization features can be disabled for the two treatment groups (e.g., which can be referred to as passive personalization). The exemplary experimental participants come from AMT (e.g., https://www.mturk.com), which is an online marketplace used for crowd sourcing micro-tasks that require human intervention (e.g., cannot be fully automated using machine learning tools).

### Exemplary Hotel Search Engine Design

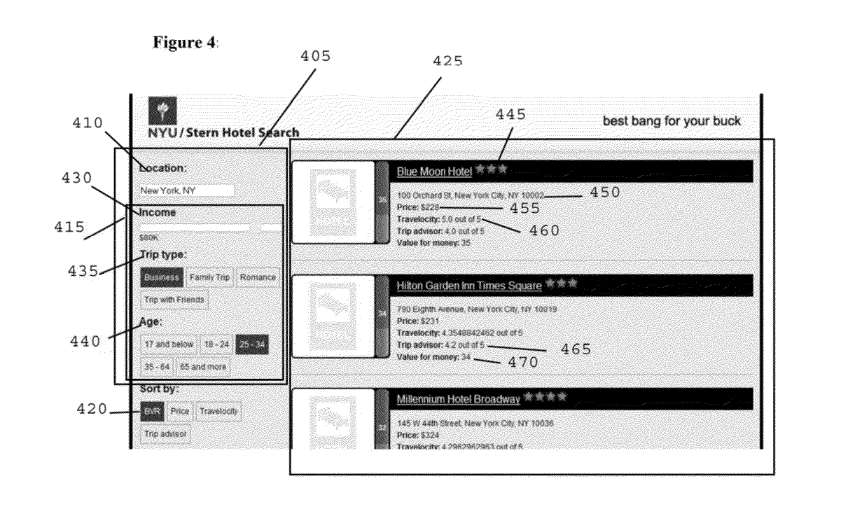

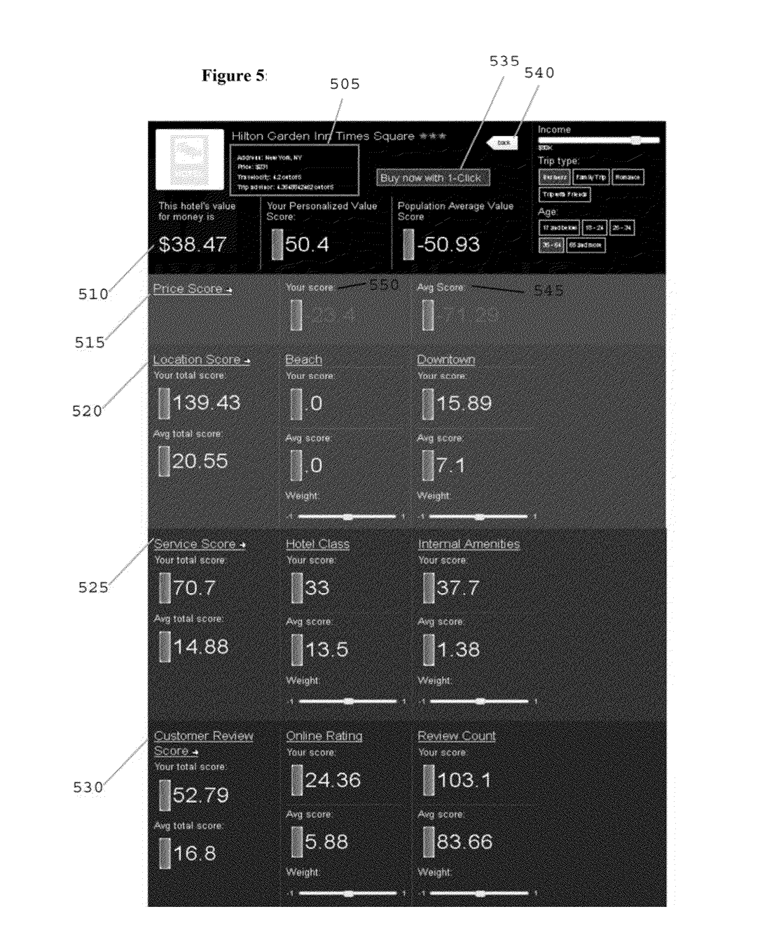

First, a real-world hotel search engine can be designed and built. This exemplary application can serve as the main instrument for the exemplary experimental studies. A screenshot of the main search interface in provided in FIG. 4. The main interface of this search engine can consist of three components: (1) Search Criteria 405, including travel destination 410 and search context 415 (e.g., demographics such as income, trip type and age); (2) Sorting Methods 420; and (3) Resulting Hotel List on the right-hand side as the response to (1) and (2).

When consumers start to search for hotels, they are able to define the travel destination 410, income level 430, trip type 435 and age group 440. Consumer trip type can be classified into four major categories: (1) business trip, (2) family trip, (3) romantic trip and (4) trip with friends. Consumer age can be classified into five groups: (1) 17 and below, (2) 18-24, (3) 25-34, (4) 35-64 and (5) 65 and older. Additionally, consumers can be provided with four different sorting methods: (1) Best-Value Rate (“BVR”), (2) price, (3) TripAdvisor.com customer rating, and (4) Travelocity.com customer rating. “BVR” can be adapted from the utility-based ranking (See, e.g., Reference 18). The value-for-money score can represent how much additional value consumers can obtain from a hotel after paying the nightly reservation rate. The acronym BVR can be used on the search engine to minimize the potential experimenter-expectancy bias that can accrue from displaying the full, expanded, label. For each hotel listed in search results 425 the summarized hotel information can be provided, including the hotel class (e.g., in pink stars 445), address 450, price 455, customer ratings from both Travelocity.com 460 and TripAdvisor.com 465, and the value for the money 470 (e.g., both in text and indicated by a vertical pink bar).

Users can view the summary information in the hotel list, and decide whether they want to click on a hotel's URL to acquire more detailed information. If a user chooses to click on a hotel's URL, he/she can be directed to that hotel's landing page. A sample hotel landing page is provided in FIG. 5. The landing page can consist of three components: (1) Search Criteria 505: similar to those on the main search page, where consumers can refine the travel destination and search context; (2) Value-for-the-Money Scores: including the hotel's overall value for the money 510 and the breakdown value score for each hotel feature (e.g., price 515, location 520, service 525 and customer reviews 530); (3) Consumer Decision: a “buy now with 1-click” button 535 that facilitates consumers to make a simulated purchase, or a “back” button 540 that takes consumers back to the main search-result page to continue searching.

For example, the value-for-the-money score 510 on the landing page can exist in two forms: (1) the population's average value score 545 and (2) the personalized value score 550. The former can represent how much value a hotel feature can provide to the overall population, whereas the latter can represent the personalized value to a specific consumer based on the search context and demographics. Moreover, each hotel feature can be associated with a “weight” that can range from −1 to +1; representing consumer preference from “strongly dislike” to “strongly favor.” A consumer can adjust the weight of his/her preference for each hotel feature to obtain a personalized value that most closely represents his/her preference. Overall, by choosing different search criteria or/and weights of preferences, a consumer can personalize the ranking results provided by the search engine.

### Exemplary Consumer-Behavior Tracking System

To further understand the complete decision-making process, the exact searching and purchasing behavior of users can be tracked. This exemplary tracking system can record the detailed information of every online activity by every consumer. For example, such activity information can include click behavior (e.g., a hotel URL being clicked, corresponding rank position, time spent on the landing page, etc.), usage of the search functions (e.g., search criteria changed, sorting methods chosen, etc.), hotel landing page browsing behavior (e.g., preference weights adjusted, search criteria changed, etc.), and purchase behavior (e.g., corresponding hotel being booked, corresponding ranking position, sorting method, etc.). Furthermore, each activity can be recorded with a time stamp captured when the activity occurs.

### Exemplary Evaluating the Impact of the Ranking Mechanism

The subjects can be asked to visit the exemplary hotel search engine website, conduct a hotel search using a set of randomly assigned search criteria and make a simulated purchase at the end. The independent variable can be the default ranking method. How the ranking mechanism affects the breadth, depth, concentration and final decision of consumer search can be of interest. Moreover, the resulting revenue for the search engine can also be of interest. Therefore, the dependent variables focused on can be (1) number of clicks; (2) time spent on evaluation; (3) number of online activities; (4) number of conversions (0 or 1); and (5) search engine revenues.

Mixed experimental design can be used. First, for the between-subjects design, a completely randomized setting with four treatment conditions can be used. The independent variable can be manipulated by changing the default ranking method for each of the four treatment groups. Each treatment group can be exposed to a different default ranking method. Each subject can be randomly assigned to only one of the four groups. Meanwhile, to control for the error variance associated with individual subject-level differences, a within-subjects design considering hotel search in two major U.S. cities can be used, (e.g., New York City and Los Angeles). Each subject can participate in two experiments corresponding to the two cities, but only in the same treatment group. The results are summarized in Table 11 a below.

### Exemplary Evaluating the Impact of Personalization

In another study, consumers' responses to different personalized ranking mechanisms can be examined. In particular, two independent variables can be focused on that can capture two different levels of personalized ranking: (1) whether it can facilitate consumers to change their personalized search context and (2) whether it can facilitate consumers to adjust their weights or preferences for different hotel features. The dependent variables can be the CTR and CR at both the subject and group levels. Moreover, the resulting search engine revenue can be of interest. For the between-subjects design, a completely randomized setting with two treatment groups and one control group can be applied. The control group can be defined as subjects who have full access to the exemplary search engine website. For the two treatment groups, everything else can be the same as in the control group, except that the two personalization features can be removed as well as, the user's ability to change the search context and to adjust weights of preferences one at a time. Meanwhile, the subject-level fixed effect by using a within-subjects design can be controlled for. The exemplary results of the design of the second study are shown in Table 1 lb.

### Exemplary Implementation

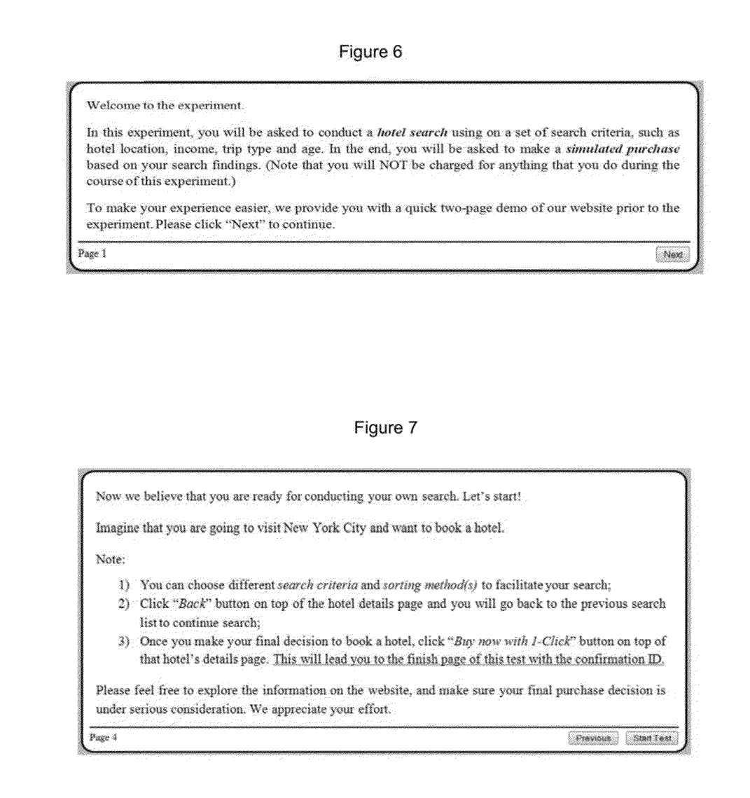

For example, 900 unique user responses were used in the exemplary experiments, with 100 for each experimental group. Users were recruited from the AMT platform. To control for quality, only those AMT workers with a prior approval rate higher than 95 percent participated in the exemplary experiments. AMT can provide an approval rate for each worker based on the frequency with which buyers have approved tasks. This approval rate can provide information on the quality of the workers. Moreover, an additional survey at the end of the experiment was designed asking the subjects to provide (1) a verification id that can automatically be generated once the experiment are properly finished, and (2) a short explanation of why they made their final decision, using at least 20 characters. This two-step process can help avoid negligent participants who have not gone through the entire experiment. With regard to the experimental procedure, a short introduction about the experiment was provided as shown in FIG. 6. To familiarize subjects with how to use the hotel-search website, a quick two-page demo of the website prior to the experiment was provided. FIG. 7 illustrates the final introduction page leading to the start of the experiment.

Exemplary Results from Randomized Experiments

Exemplary Ranking Effect on Click and Purchase Propensities

How the design of ranking mechanisms can affect different aspects of user behavior on search engines can be examined. The total time spent, number of online activities and number of clicks at the subject level, and the overall purchase propensity from each of the four treatment groups can also be examined. Table 12 shows the final purchase propensities under different ranking mechanisms. Subjects who get to see BVR as the default ranking paid more attention and displayed higher purchase propensities than subjects from other groups. This result can be significant at the p=0.05 level based on a post hoc ANOVA test. Price-based ranking provided the second-best performance on these two dimensions, followed by the rankings based on TripAdvisor and Travelocity ratings, respectively. Moreover, this finding can be consistent across the two cities (e.g., New York City and Los Angeles). This exemplary result shows how the design of ranking mechanisms can affect the performance of a product search engine.

A significant ranking effect can be found at the individual hotel level. Hotels ranked at the top of the search result list received, on average, about 2.39 times more clicks compared to the second-ranked hotels, and about 3.42 times more compared to the third-ranked hotels. This trend remained consistent across two cities, regardless of the default ranking method. Table 13 shows the number of clicks received for hotels ranked in the top 10.

The CTR for the same hotel that appeared in different ranking positions under different default ranking mechanisms was examined. Controlling for everything else, the same hotel in a higher screen position received significantly more clicks. For example, the “Blue Moon Hotel” in New York City received a total of 56 clicks under the BVR ranking, in which it was ranked at position 1. However, the same hotel received zero clicks under the price-based ranking, in which it was ranked 31.

Exemplary Ranking Effect on Search Engine Revenue

How different ranking systems affect overall search engine revenues can be of interest. The overall search engine revenues can be computed by multiplying the unit price by the number of conversions for each hotel, and then summing over all hotels in the experiments. Results are shown in Table 14.

The exemplary experimental results can be consistent with the policy experiment results from previous archival data analysis. It was found that price-based ranking can lead to the highest search engine revenue received from the top-ranked hotel. However, BVR (e.g. consumer-utility-based) ranking leads to the highest overall revenue from all the hotels. Moreover, experimental evidence can be found that under the BVR ranking, a significant part of the overall revenue can come from hotels that can be ranked lower on the computer screen, which can be different from the other competing ranking mechanisms.

These experimental findings support the previous policy experiment. They can indicate consumers prefer the diversity in the utility-based ranking Diversity presented in the ranking list can lead to a significant increase in conversions, especially from the lower-ranked products. Moreover, these additional conversions can contribute significantly to the overall revenue for search engines.

Exemplary Interaction Effect between Ranking and Hotel Class Rating.

The exemplary differences in CTR from different ranking positions for two different “classes” of hotels, luxury- and budget-class hotels can be examined. In particular, the changes in CTR at different ranking positions for either 4- or 5-star hotels (e.g., luxury hotels) and for 3-star or lower hotels (e.g., budget hotels) can be examined. It was found that as one moves down from the top-ranked position to a lower-ranked position, the decrease in CTR for luxury hotels can be much larger than that for budget hotels. For example, moving down from the top to the fifth position leads to a 75% drop in CTR for the luxury hotels compared to a 54% drop for the budget hotels. Different ranking positions were tested using a robustness check, and the results were found to be very consistent. Table 15a shows the changes in the click-through rate of hotels when moving down from the top position to the third, fifth, and tenth position.

Exemplary Interaction Effect between Ranking and Customer Rating.

The exemplary differences in CTR from different ranking positions for hotels with higher customer ratings compared to those with lower customer ratings can be examined. In particular, the CTR can be compared at different ranking positions for 4- to 5-star hotels, as rated by reviewers, versus 1- to 2-star hotels. The increase in CTR resulting from hotels moving from a lower-to a higher-ranked position was greater for hotels with a poor reputation than for hotels with good reputation. For example, moving up from the 10th-ranked position to the top position increases CTR by 245% for hotels with low user ratings compared to an increase of 83% for hotels with high user ratings. Table 15b shows the corresponding changes in the CTR of hotels moving up from the 10th position to the fifth, third, and top position.

Exemplary findings in Tables 15a and 15b can provide important insights and additional support to the archival data analysis, indicating that luxury hotels can be more sensitive to the ranking effect and can be more adversely affected by an inferior screen position. Meanwhile, hotels that receive a lower reputation from online word-of-mouth benefit more when placed at the top of the search results. The exemplary findings illustrate the benefit for product search engines to directly incorporate signals from online social media into the ranking procedures.

Exemplary Effect of Personalized Ranking on Click and Purchase Propensities.

One of the further exemplary goals of the exemplary system, method and computer-accessible medium, can be to examine how different personalized ranking mechanisms can influence the way consumers behave on product search engines. For example, three levels of personalization can be considered: (1) active personalized ranking with full access (e.g. control group, henceforth “FULL_ACCESS”), (2) passive personalized ranking without search context (e.g. treatment group 1, henceforth “NO_SEARCH”), and (3) passive personalized ranking without weights of individual preferences (e.g. treatment group 2, henceforth “NO_WEIGHT”). Table 16 summarizes the average user behavior in terms of total time spent and total number of activities under the three different exemplary personalization mechanisms.

For example, the active personalized ranking mechanism can result in more user time and more activities than the two passive mechanisms. Each user, on average, spent approximately 351 seconds and conducts about 19 activities per session when exposed to active personalized ranking This finding can suggest an active personalized ranking can generate higher online engagement on the search engine. The NO_WEIGHT group with passive personalized ranking demonstrated the lowest level of user engagement. This step can provide a “sanity check” that these different personalization features can influence user behavior in the exemplary experiments.

Table 17 displays the average number of clicks made by a user, and the overall purchase propensity for the two different cities, under the three personalized ranking mechanisms. It was found that a travel search engine with an active personalized ranking mechanism can attract significantly more clicks than those with passive mechanisms. However, active personalized ranking can lead to a significantly lower purchase propensity. This finding was consistent across the two different cities, and can be important because one would expect the active personalized ranking mechanism to increase, rather than decrease, the purchase propensities. One possible explanation can be related to consumer expectations. In most online shopping environments, consumers find active personalization especially useful because it helps them discover what they want to buy before they know it themselves. In other words, the active personalized ranking can be more likely to increase sales when consumers have not planned their purchase beforehand. In the exemplary setting, the type of consumers who has planned their purchase before the search starts was focused on. Under such a scenario, the major advantage of active personalized ranking can be lost on consumers because they already have in mind what they are searching for. If the personalization results do not meet consumers' expectations, they can easily stop the sale. This finding can be in line with previous findings (see, e.g., Reference 61), which show the mismatch between the specificity of the ad content and whether a consumer has well-defined preferences that can lead to ineffective personalization. Another plausible explanation can be related to consumers' cognitive limitations. The ability to extensively search and change their current consideration sets under the active personalized ranking mechanism can lead to information overload during the decision-making process. As a consequence, consumers can end up being confused or frustrated, and therefore skip buying completely.

Comparing the NO_SEARCH group with the FULL_ACCESS group, the additional personalization based on search context and demographics (e.g., “search-based” personalization) can result in a larger negative effect on purchase propensity (e.g., 6% larger for LA and 3% larger for NYC) than when the NO_WEIGHT group is compared with the FULL_ACCESS group. This finding can provide two plausible explanations of personal information that can be used in the personalization process in the exemplary context (1) user identity related (e.g., who are you?) and (2) user-preferences-related (e.g., what do you like?). Search context and demographic information can lie closer to the former category, whereas weights of location and service preferences can belong to the latter. The exemplary results can suggest that when designing a personalized ranking mechanism, using the identity-related information can be less beneficial, not only for privacy-preserving purposes, but also for the economic outcomes such as conversions.

The exemplary findings above can be directly observed at the search engine level. To verify the effects of active and passive personalized ranking mechanisms, two further analyses can be conducted at the individual-subject level. First, the user-level number of clicks can be considered as the dependent variable in the exemplary analysis. The independent variables of interest can be two dummies: NOSEARCH and NOWEIGHT, corresponding to the two passive personalized ranking treatment groups, respectively. Because the number of clicks can be a nonnegative integer, a count data model can be used, as well as the negative binomial model with robust error. For estimation, the maximum likelihood method can be applied. To control for the location effect, a city dummy variable can be included which can denote whether it is New York City or Los Angeles. Moreover, from the previous analysis, it can be noticed that the number of consumer activities can drop significantly in the case of NOWEIGHT. Therefore, to control for the level of online attention, the number of total activities at subject level can be included as an additional control variable. The results can be qualitatively consistent as displayed in columns 2-4 in Table 18. Both NOSEARCH and NOWEIGHT can illustrate significant negative effect on the number of clicks, which means the presence of personalization in search context and weights of preferences can have significant positive effects on the clicks at the individual level. The ability to define their search criteria on specific contexts and to adjust their preferences toward product features, can lead to more clicks.

Second, the user-level purchase propensity as the dependent variable in analysis can be considered. Two independent variables can be of interest: NOSEARCH and NOWEIGHT. Each subject can be asked to make a purchase at the end. However, subjects can still decide not to do so. Thus the purchase outcome can be a binary variable: 0 or 1. Therefore, the probit model can be applied with a maximum likelihood method for estimation. Again, two additional control variables can be included: (1) city dummy and (2) number of total activities. The results are displayed in columns 2-4 in Table 19. Both NOSEARCH and NOWEIGHT can have a statistically significant positive sign. This finding can suggest the presence of personalization in search context and individual preferences can have significant negative effects on the purchase propensity at the individual level. This result can be consistent with the previous analysis at the search engine level. It can indicate the active personalized ranking mechanism can lead to a significant decrease in consumer purchase propensity.

Exemplary Effect of Personalized Ranking on Search Engine Revenue

How active and passive personalized ranking mechanisms can affect the revenue for search engines can be of interest. Consistent with the previous definition, a sum can be taken over all hotels to compute the overall search engine revenue. It can be found that the active personalized ranking mechanism can lead to significantly lower overall revenues than the two passive mechanisms in the exemplary travel search engine. This finding can provide further insight that the decrease in purchases due to the improper use of the active personalized ranking strategy can result in a decrease in the overall revenue for product search engines. Thus, implementing the active personalized ranking mechanism may not always be profitable for product search engines. Results are shown in the last column in Table 17.

Exemplary Further Robustness Tests

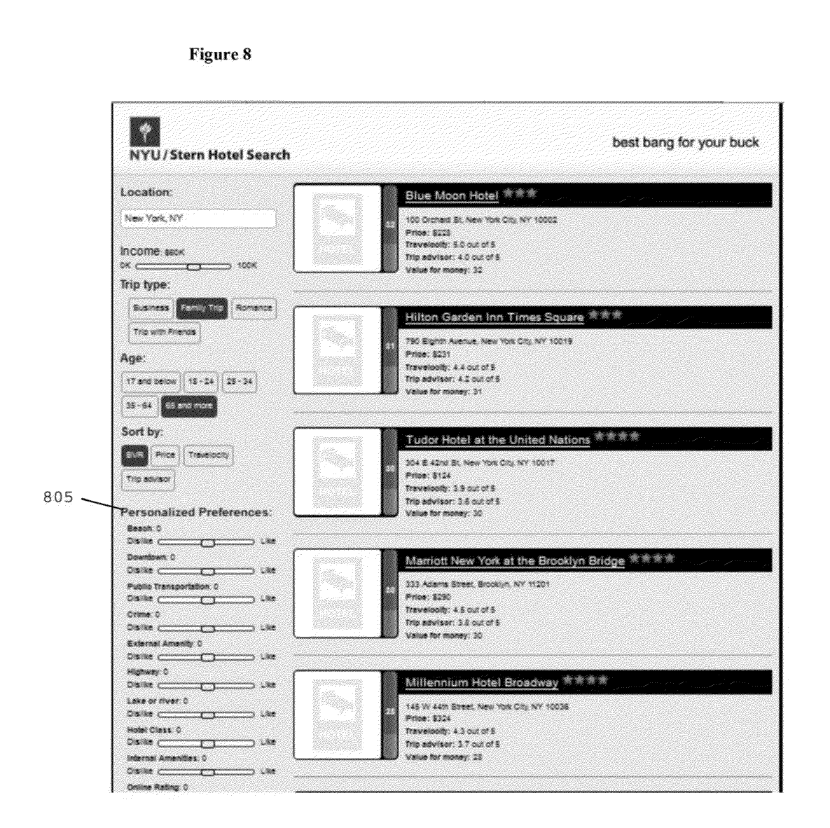

To further test the validity of the exemplary results, two further robustness tests can be performed by considering two additional situations. First a setting with an even higher level of active personalization can be considered. Consumers who are randomly assigned to this setting can be granted full access to active personalized ranking, as in the previous setting. Moreover, they can adjust their individual weights of preferences not only on the hotel landing page, but also on the main search page. The value score for each hotel, and the corresponding BVR ranking, can be adjusted instantly based on the weight preferences consumers choose on the search page. The search interface for this robustness test is shown in FIG. 8, which contains sliders providing users with the ability to modify personalized preferences 805.

A similar trend can be found when comparing the case of active personalized ranking with passive personalized ranking In the new setting, users tend to spend even more time (e.g., an average of about 343.02 sec) and conduct even more activities (e.g., an average of about 19.27 activities) on the search engine than in the two passive personalized ranking scenarios. These two statistics again serve as good manipulation checks, indicating users are indeed using the personalization features. Furthermore, the high-level active personalization can lead to a significantly lower purchase propensity, and lower search engine revenue compared to the two passive mechanisms. This result strongly supports the previous findings obtained from both the archival data analysis and the experiment regarding whether excess information discourages consumers from making final decisions. Improper use of the active personalized ranking mechanism can lead to a loss of profit for product search engines. The detailed results are shown in Table 20.

Second, to test consumers' behavior when they have a less structured purchase plan in mind, a more general purchase situation can be considered in which, rather than having to make a planned purchase at the end of each search session, consumers can choose to leave the search session without making a purchase. For comparison, consumers who are randomly assigned to this setting receive full access to the active personalized ranking recommendation.

For example, in the case of active personalization with an “unplanned purchase,” the average time users spend on the site drops to nearly half of that in the case of active personalization with a “planned purchase” (e.g., about 177.01 sec vs. about 351.23 sec). However, the average number of activities in which users engage in the two cases remains similar (e.g., about 18.18 vs. about 19.36). Furthermore, in the case of active personalization with an “unplanned purchase,” purchase propensities increase compared to the case of a “planned purchase.” The results are consistent across the two cities.

This exemplary finding can suggest active personalized ranking can be more effective when consumers generally do not have a well-structured purchase plan. In such cases, they can be more likely to discover potentially relevant products. However, this scenario may not be the case when consumers already have a clear purchase plan. Consumers can be highly discouraged, and can terminate the search completely, if the active personalized ranking results mismatch their original expectations. This test can provide additional insights into the main findings, suggesting active personalized ranking should not be adopted blindly, and the level of personalization should be carefully designed based on the search context. The detailed results are provided in Table 21.

Exemplary Conclusions and Implications

The exemplary system, method and computer-accessible medium, according to an exemplary embodiment of the present disclosure, can analyze three major issues that product search engines increasingly face: (1) the direct effect of ranking mechanism on consumer behavior and search engine revenue; (2) the interaction effect of ranking and product ratings; and (3) what kind of personalized ranking mechanism, if any, to adopt. Archival data analysis can be combined with randomized experiments based on an exemplary hotel search engine application. By manipulating the default ranking method and enabling or disabling a variety of active personalization features on the hotel search engine website, consumer behavior and search engine revenue can be analyzed under different scenarios.

The exemplary experimental results on ranking can be consistent with those from Bayesian model-based archival data analysis, which can suggest a significant and causal effect of search engine ranking on consumer click and purchase behavior. In addition a consumer-utility-based ranking mechanism can yield the highest purchase propensity and the highest search engine overall revenue compared to existing benchmark systems, such as ranking based on price or star ratings. Moreover, an inferior screen position tends to more adversely affect luxury hotels and more expensive hotels. Hotels with lower reputations benefit more from being placed at the top of the search results. This finding can illustrate the benefit for product search engines to directly incorporate signals from online social media into the ranking procedures. Google began to incorporate tweets and other social media status updates into its real-time search function, and then decided to create its own version of the Facebook Like button, the Google +1, and have it show up in search results. In another example of the interplay between social media and search, Microsoft's search engine Bing is now incorporating Facebook updates in its results.

The exemplary experimental results on personalized ranking can show that the availability of excess personalization capabilities during the decision-making process can discourage consumers from searching, evaluating and making final choices. In particular, it can be found that although active personalized ranking, compared to passive personalized ranking, can attract more online attention from consumers, it can lead to a lower purchase propensity, and lower search engine revenue. This finding can suggest personalized ranking should not be adopted blindly and the level of personalization should be carefully designed based on the search context. The exemplary system, method and computer-accessible medium can shed light on how consumers search, evaluate choices and make purchase decisions in response to differences in product search engine designs. A good ranking mechanism can reduce consumers' search costs, improve click-through rates and conversion rates of products and improve revenue for search engines.

The exemplary system, method and computer-accessible medium, according to an exemplary embodiment of the present disclosure, can utilize a structural model for predictive digital analytics by product search engines to predict consumers' online search paths as well as to measure and quantify the search costs incurred by user. The exemplary model can combine an optimal stopping framework with an individual-level random utility choice model. It can facilitate the ability to jointly estimate consumers' heterogeneous preferences, and search costs in a product search engine context, where social media can be quite pervasive, and to identify the key driver of a consumer's decision at each stage of the search and purchase process. The exemplary analytical results can help product search engines predict and cache the “most likely-to-be-visited” web pages beforehand to minimize the response time and improve user experience.

The exemplary system, method and computer-accessible medium, can show the advantage of incorporating multiple, and large, data sources to analyze how humans search, evaluate information and make decisions under cognitive constraints (e.g., search cost) in response to the emerging interplay between social media and search engines. Moreover, the exemplary system, method and computer-accessible medium can quantify the interaction effects of social media and search engines on user search cost. The exemplary empirical analysis can provide a rigorous approach for future studies to build on, with the goal of exploring the tremendous potential of “Big Data” and sophisticated customer analytics tools for managerial decision-making Additionally, the value of using predictive digital analytics by search engines based on structural econometric methods in finding new solutions for important business problems can be demonstrated. The exemplary dynamic model for consumer search can combine the optimal stopping framework with an individual-level random utility choice model. It can facilitate the ability to harness the advantage of multistage consumer behavioral data on search engines to identify the drivers of consumer decisions in electronic markets. It can also enable the prediction of consumers' future search paths on product search engines, and thereby the design of effective web caching strategies for search engines to improve the user experience. The exemplary system, method and computer-accessible medium, according to an exemplary embodiment of the present disclosure, can be generalized to any electronic market with an in-house search engine (e.g., Amazon.com, BestBuy.com and Apple's iTunes store) given the commonality in the goal of reducing website latency and improving user experience.

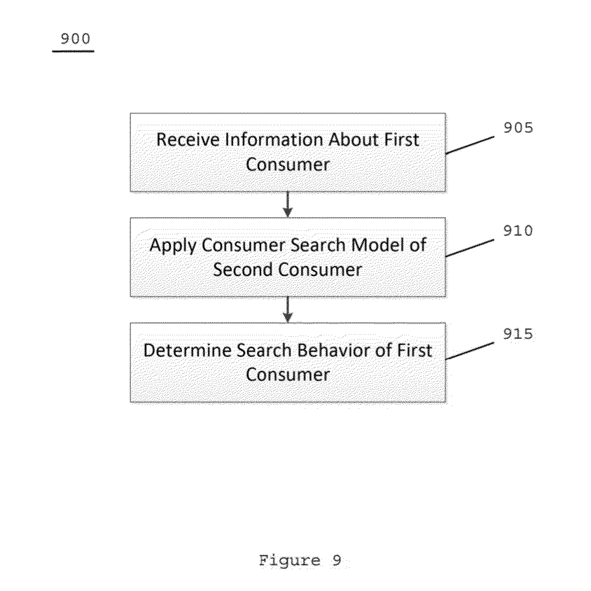

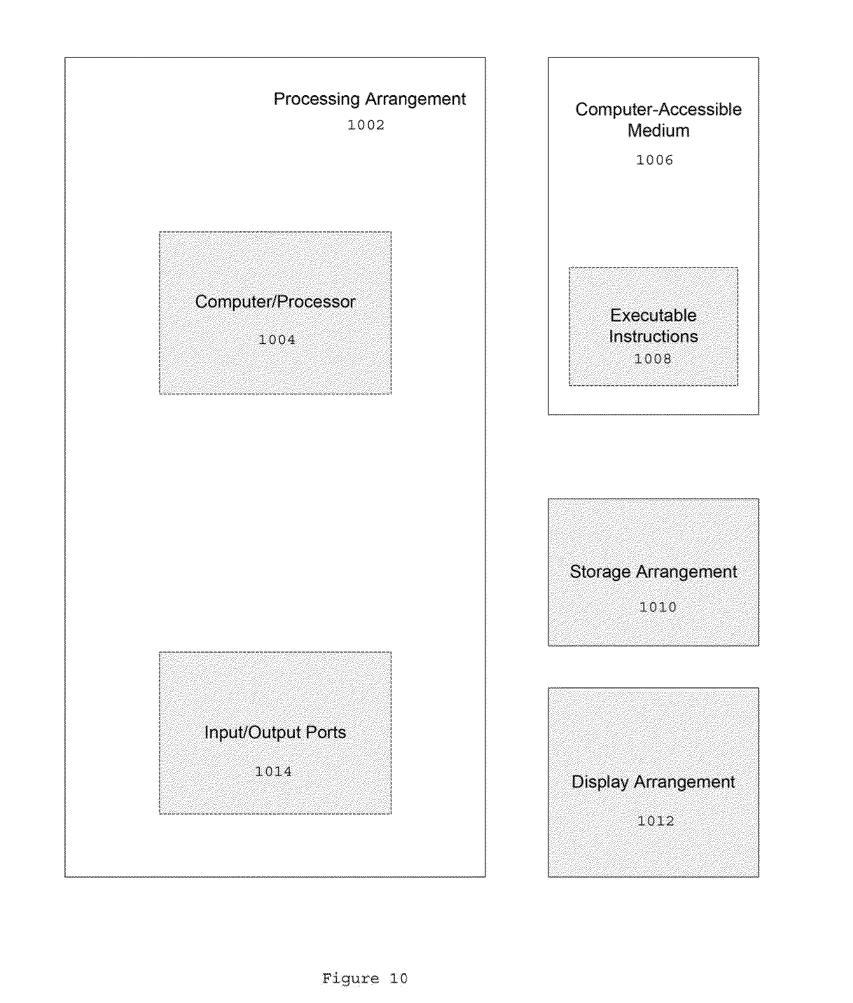

FIG. 9 illustrates an exemplary method 900 for determining the search behavior of a consumer according to an exemplary embodiment of the present disclosure which can be executed by a processor and/or computer of a system (e.g., an example of which shown in FIG. 10) that is specifically programmed to perform such execution. For example, at procedure 905, information about a first consumer can be received. At procedure 910, a consumer search model of a second consumer, that can be based on heterogeneous preferences and a search cost model of the second consumer can be applied to the received information. At procedure 915, the search behavior of the first consumer can be determined based on the consumer search model.

FIG. 10 shows a block diagram of an exemplary embodiment of a system according to the present disclosure. For example, exemplary procedures in accordance with the present disclosure described herein can be performed by a processing arrangement and/or a computing arrangement 1002. Such processing/computing arrangement 1002 can be, for example, entirely or a part of, or include, but not limited to, a computer/processor 1004 that can include, for example, one or more microprocessors, and use instructions stored on a computer-accessible medium (e.g., RAM, ROM, hard drive, or other storage device).

As shown in FIG. 10, for example, a computer-accessible medium 1006 (e.g., as described herein above, a storage device such as a hard disk, floppy disk, memory stick, CD-ROM, RAM, ROM, etc., or a collection thereof) can be provided (e.g., in communication with the processing arrangement 1002). The computer-accessible medium 1006 can contain executable instructions 1008 thereon. In addition or alternatively, a storage arrangement 1010 can be provided separately from the computer-accessible medium 1006, which can provide the instructions to the processing arrangement 1002 so as to configure the processing arrangement to execute certain exemplary procedures, processes and methods, as described herein above, for example.

Further, the exemplary processing arrangement 1002 can be provided with or include an input/output arrangement 1014, which can include, for example, a wired network, a wireless network, the internet, an intranet, a data collection probe, a sensor, etc. As shown in FIG. 10, the exemplary processing arrangement 1002 can be in communication with an exemplary display arrangement 1012, which, according to certain exemplary embodiments of the present disclosure, can be a touch-screen configured for inputting information to the processing arrangement in addition to outputting information from the processing arrangement, for example. Further, the exemplary display 1012 and/or a storage arrangement 1010 can be used to display and/or store data in a user-accessible format and/or user-readable format.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures which, although not explicitly shown or described herein, embody the principles of the disclosure and can be thus within the spirit and scope of the disclosure. Various different exemplary embodiments can be used together with one another, as well as interchangeably therewith, as should be understood by those having ordinary skill in the art. In addition, certain terms used in the present disclosure, including the specification, drawings and claims thereof, can be used synonymously in certain instances, including, but not limited to, for example, data and information. It should be understood that, while these words, and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

### Exemplary Tables

TABLE 2
Definitions and Summary Statistics of Variables

| Variable | Definition | Mean | St. Dev. | Min | Max. |
|---|---|---|---|---|---|
| PRICE_DISP | Displayed price per room per night | 230.98 | 179.76 | 16 | 2849 |
| PRICE_TRANS | Transaction price per room per night | 148.08 | 108.18 | 52 | 2252 |
| COMPLEXITY | Average sentence length per review | 17.50 | 3.77 | 4 | 44 |
| SYLLABLES | Average # syllables per review | 246.81 | 50.53 | 76 | 700 |
| SPELLERR | Average # spelling errors per review | 1.17 | .33 | 0 | 3.86 |
| SUB | Review subjectivity - mean | .91 | .03 | .05 | 1 |
| SUBDEV | Review subjectivity - standard deviation | .02 | .03 | 0 | .25 |
| CLASS | Hotel class | 3.62 | .70 | 1 | 5 |
| AMENITYCNT | Total # hotel amenities | 14.37 | 6.22 | 2 | 23 |
| ROOMS | Total number of hotel rooms | 210.12 | 258.27 | 12 | 2900 |
| REVIEWCNT | Total # reviews | 13.56 | 25.60 | 0 | 202 |
| RATING | Overall reviewer rating | 3.94 | .39 | 1 | 5 |
| PAGE | Page number of the hotel | 20.86 | 13.44 | 1 | 192 |
| RANK | Screen position of the hotel | 12.09 | 4.32 | 1 | 25 |
| SPECIALSORT | Dummy for a special sorting method | .10 | .30 | 0 | 1 |
| BEACH | Beachfront within 0.6 miles | .19 | .36 | 0 | 1 |
| LAKE | Lake or river within 0.6 miles | .23 | .44 | 0 | 1 |
| TRANS | Public transportation within 0.6 miles | .31 | .45 | 0 | 1 |
| HIGHWAY | Highway exits within 0.6 miles | .70 | .42 | 0 | 1 |
| DOWNTOWN | Downtown area within 0.6 miles | .66 | .45 | 0 | 1 |
| EXTAMENITY | Number of external amenities within 1 | 4.63 | 7.99 | 0 | 27 |
| CRIME | City annual crime rate | 194.99 | 127.22 | 3 | 1310 |
| BRAND | Dummies for 9 hotel brands: Accor, | — | — | 0 | 1 |
| | Best western, Cendant, Choice, | | | | |
| | Hilton, Hyatt, Intercontinental, | | | | |
| | Marriott, and Starwood | | | | |

Total # Sessions: 969,033
Total # Hotels: 2117
Time Period: Nov. 1, 2008-Jan. 31, 2009

TABLE 3
Estimation Results—Main Results and Robustness Tests (I) & (II)

| | Mean Effect | | Heterogeneity | | Mean Effect | | Heterogeneity | | Mean Effect | | Heterogeneity | |
|---|---|---|---|---|---|---|---|---|---|---|---|---|
| Variable | (Std. Err)^{M} | | (Std. Err)^{M} | | (Std. Err)^{R1} | | (Std. Err)^{R1} | | (Std. Err)^{R2} | | (Std. Err)^{R2} | |
| (Preferences) | α̅, β̅ | | σ_{α}, Ε_{β} | | α̅, β̅ | | σ_{α}, Ε_{β} | | α̅, β̅ | | σ_{α}, Ε_{β} | |
| PRICE^{(L)} | −1.423* | (.000) | 0.578* | (.023) | −1.925* | (.001) | 0.740* | (.001) | −2.531* | (.021) | 1.137* | (.019) |
| CLASS | 1.667* | (.002) | 1.377* | (.087) | 1.729* | (.003) | 1.702* | (.004) | 2.023* | (.062) | 2.010* | (.015) |
| RATING | 3.199* | (.003) | 1.923* | (.021) | 3.543* | (.007) | 1.188* | (.005) | 3.776* | (.038) | 1.344* | (.032) |
| AMENITYCNT^{(L)} | .053* | (.006) | .004 | (.032) | .076* | (.003) | .007 | (.040) | .115* | (.023) | .019 | (.102) |
| REVIEWCNT^{(L)} | 1.411* | (.003) | 1.405* | (.090) | 1.599* | (.006) | 1.211* | (.004) | 1.878* | (.031) | 0.624* | (.021) |
| ROOMS(L) | 1.005* | (.002) | .056 | (.071) | 1.336* | (.023) | .049 | (.056) | 1.602* | (.106) | .077 | (.110) |
| EXTAMENITY^{L)} | .082* | (.001) | .005 | (.024) | .064* | (.011) | .014 | (.033) | .089* | (.035) | .058 | (.097) |
| BEACH | 1.001* | (.010) | .072* | (.012) | 1.545* | (.012) | .081* | (.022) | 1.892* | (.001) | .063* | (.018) |
| LAKE | −.767* | (.089) | 1.356* | (.059) | −.702* | (.065) | 1.203* | (.044) | −1.005* | (.047) | 1.986* | (.263) |
| TRANS | 1.046* | (.003) | .043* | (.029) | 1.067* | (.008) | .068 | (.067) | 1.288* | (.142) | .089 | (.211) |
| HIGHWAY | .602* | (.091) | .070* | (.005) | .559* | (.076) | .043* | (.013) | .304* | (.060) | .066 | (.053) |
| DOWNTOWN | .586* | (.004) | .116* | (.047) | .534* | (.017) | .123* | (.052) | .707* | (.196) | .283* | (.075) |
| CRIME | −.112* | (.001) | .017 | (.036) | −.179* | (.006) | .010 | (.049) | −.181* | (.083) | 0.037 | (.102) |

| BRAND | Yes | | | | | | | | | |
|---|---|---|---|---|---|---|---|---|---|---|
| (Search Cost) | γ̅ | | Ε_{γ} | | γ̅ | | Ε_{γ} | | γ̅ | Ε_{γ} |
| Search Base Cost | −2.287* | | 1.463* | (.004) | −2.531* | | 1.620* | (.015) | — | — |
| PAGE | 4.017* | (.002) | 1.633* | (.003) | 3.598* | (.012) | 1.147* | (.002) | — | — |
| RANK | 2.178* | (.006) | 0.340* | (.001) | 2.241* | (.011) | 0.276* | (.001) | — | — |
| SPECIALSORT | −2.582* | | 5.835* | (.023) | 2.103* | (.014) | 4.669* | (.024) | — | — |
| AMENITYCNT^{(L)} | 0.343* | (.005) | 0.146* | (.001) | 0.389* | (.006) | 0.158* | (.001) | — | — |

| | | | | | | | | |
|---|---|---|---|---|---|---|---|---|
| REVIEWCNT^{L)} | 0.500* | (.005) | 0.211* | (.005) | — | — | — | — |
| COMPLEXITY | 1.349* | (.011) | 0.142* | (.006) | — | — | — | — |
| SYLLABLES^{L)} | 1.668* | (.015) | 0.378* | (.010) | — | — | — | — |
| SPELLERR^{L)} | 0.814* | (.005) | 0.290* | (.008) | — | — | — | — |
| SUB | 0.205* | (.002) | 0.079* | (.001) | — | — | — | — |
| SUBDEV | 0.822* | (.019) | 0.102* | (.007) | — | — | — | — |

| | | | |
|---|---|---|---|
| Maximum LL | 477587.023619 | 477342.002341 | 125786.702515 |

(L)Logarithm of the variable. *Statistically significant at 5% level. M: Main estimation results. R1: Robustness Test I (Exclude Social Media Variables). R2: Robustness Test II (Mixed Logit with Actual Limited

TABLE 4
Robustness Test (III)—Interaction Effects Between Travel Purpose and
Sorting Criterion on Search Cost

| | DFT | | PRA | | CLD | | CLA | | CNA | HNA | |
|---|---|---|---|---|---|---|---|---|---|---|---|
| Family | −2.452″ | (.079) | −1.007″ | (.391) | 0.780″ | (.152) | 1.291″ | (.171) | — | −0.145 | (.462) |
| Business | −1.757″ | (.186) | .989″ | (.241) | 1.073″ | (.227) | — | | — | −2.076″ | (.108) |
| Romance | −1.289″ | (.211) | 1.203″ | (.052) | −0.323 | (.389) | 3.030″ | (.782) | — | −0.417″ | (.068) |

| | | | | | | | | | | |
|---|---|---|---|---|---|---|---|---|---|---|
| Tourist | −0.836″ | (.233) | −1.869″ | (.543) | 1.690 | (1.746) | — | — | −0.674 | (1.375) |
| Kids | 0.535 | (.662) | 0.763 | (1.041) | 0.204″ | (.538) | — | — | −0.422 | (.706) |
| Senior | 1.065 | (1.753) | −0.537″ | (.138) | 1.021 | (1.249) | — | — | −0.701″ | (.043) |

| | | | | | | | | | |
|---|---|---|---|---|---|---|---|---|---|
| Pets | 0.302 | (.998) | 0.799 | (1.015) | −0.693 | (.828) | — | — | — |

*Statistically significant at 5% level.
Note:
Some interaction effects are dropped in the estimation due to practical reasons (e.g., collinearity or very low significance).

TABLE 5a
In-sample Model Prediction Results (Click Probability)

| | | Mixed Logit | Mixed Logit | Mixed Logit | Mixed Logit |
|---|---|---|---|---|---|
| | | Model with | Model with | (Full Choice Set) + | (Limited Choice Set) + |
| | Search | Full | Limited | Additional Search | Additional Search |
| | Model | Choice Set | Choice Set | Cost Variables | Cost Variables |
| RMSE | 0.0387 | 0.0803 | 0.0442 | 0.0696 | 0.0401 |
| MSE | 0.0015 | 0.0064 | 0.0020 | 0.0048 | 0.0016 |
| MAD | 0.0112 | 0.0357 | 0.0163 | 0.0210 | 0.0155 |

TABLE 5b
Out-of-sample Model Prediction Results (Click Probability)

| | | Mixed Logit | Mixed Logit | Mixed Logit | Mixed Logit |
|---|---|---|---|---|---|
| | | Model with | Model with | (Full Choice Set) + | (Limited Choice Set) + |
| | Search | Full | Limited | Additional Search | Additional Search |
| | Model | Choice Set | Choice Set | Cost Variables | Cost Variables |
| RMSE | 0.0891 | 0.1902 | 0.1333 | 0.1887 | 0.1026 |
| MSE | 0.0079 | 0.0362 | 0.0178 | 0.0356 | 0.0105 |
| MAD | 0.0299 | 0.0712 | 0.0385 | 0.0532 | 0.0334 |

TABLE 6a
In-sample Model Prediction Results (Purchase Probability)

| | | Mixed Logit | Mixed Logit | Mixed Logit | Mixed Logit |
|---|---|---|---|---|---|
| | | Model with | Model with | (Full Choice Set + | (Limited Choice Set) + |
| | Search | Full | Limited | Additional Search | Additional Search |
| | Model | Choice Set | Choice Set | Cost Variables | Cost Variables |
| RMSE | 0.0502 | 0.0771 | 0.0607 | 0.0723 | 0.0589 |
| MSE | 0.0025 | 0.0059 | 0.0037 | 0.0052 | 0.0035 |
| MAD | 0.0178 | 0.0242 | 0.0215 | 0.0229 | 0.0197 |

TABLE 6b
Out-of-sample Model Prediction Results (Purchase Probability)

| | | Mixed Logit | Mixed Logit | Mixed Logit | Mixed Logit |
|---|---|---|---|---|---|
| | | Model with | Model with | (Full Choice Set) + | (Limited Choice Set) + |
| | Search | Full | Limited | Additional Search | Additional Search |
| | Model | Choice Set | Choice Set | Cost Variables | Cost Variables |
| RMSE | 0.1002 | 0.1767 | 0.1446 | 0.1602 | 0.1285 |
| MSE | 0.0100 | 0.0312 | 0.0209 | 0.0257 | 0.0165 |
| MAD | 0.0383 | 0.0658 | 0.0505 | 0.0582 | 0.0473 |

TABLE 7
Definitions and Summary Statistics of Variables

| Variable | Definition | Mean | Std. Dev. | Min | Mm |
|---|---|---|---|---|---|
| PRICE | Transaction price per room per night | 120.45 | 73.25 | 25.77 | 978 |
| DISPLAY | Number of displays | 213.65 | 382.28 | 1 | 4849 |
| CLICK | Number of clicks | 2.99 | 3.55 | 0 | 56 |
| CONVERSION | Number of conversions | 1.26 | 0.66 | 0 | 9 |
| PAGE | Page number of the hotel | 20.86 | 13.44 | 1 | 192 |
| RANK | Screen position of the hotel within a page | 12.09 | 4.32 | 1 | 25 |
| CLASS | Hotel class | 3.36 | 1.37 | 1 | 5 |
| REVIEWCNT | Total number of reviews | 21.06 | 29.28 | 1 | 202 |
| RATING | Overall reviewer rating | 3.84 | .85 | 1 | 5 |
| SPECIALSORT | Vector of six control variables indicating the | | | | |
| | frequency of using different sorting methods | | | | |
| DFT | Default sorting | 188.50 | 369.58 | 0 | 4711 |
| PRA | Price Ascending | 13.99 | 23.34 | 0 | 338 |
| CLD | Class Descending | 1.49 | 3.42 | 0 | 37 |
| CLA | Class Ascending | 0.16 | 0.65 | 0 | 11 |
| CNA | City Name Ascending | 0.13 | 0.54 | 0 | 9 |
| HNA | Hotel Name Ascending | 0.35 | 0.95 | 0 | 15 |
| H | Total number of hotels in a city | 24.03 | 56.48 | 1 | 922 |
| BRAND | Dummies for 9 hotel brands: Accor, Best | — | — | 0 | 1 |
| | western, Cendant, Choice, Hilton, Hyatt, | | | | |
| | Intercontinental, Marriott, and Starwood | | | | |

Number of Observations (Weekly-Level): 29,222
Time Period: Nov. 1, 2008-Jan. 31, 2009

Table 8 Main Results from Model Estimation

TABLE 8a
Coefficient Estimates from Clickthrough Model

| | Mean | Class | Price^{(L)} | Rating |
|---|---|---|---|---|
| Intercept | 1.049(.054)* | .040(.011)* | — | — |
| Rank | −.062(.007)* | −.026(.004)* | −.019(.004)* | .020(.003)* |
| Rank² | .004(.000)* | — | — | — |
| Page | −.035(.004)* | −.007(.001)* | −.011(.005)* | .016(.002)* |
| Price^{(L)} | −.141(.021)* | .002(.000)* | — | .004(.000)* |
| Rating | .078(.015)* | .001(.002) | — | — |
| ReviewCnt(L) | .033(.009)* | .029(.032) | −.002(.023) | .017(.003)* |
| H(L)(Total #of Hotels) | −.007(.000)* | — | — | — |

| | |
|---|---|
| Brand | Yes |
| SpecialSort(L) | Yes |

Unobserved Heterogeneity Estimates (Covariance Matrix Σ^{b})

| | Intercept | Rank | Page | Price | Rating | ReviewCnt(L) |
|---|---|---|---|---|---|---|
| Intercept | 1.012(.041)* | — | — | — | — | — |
| Rank | −.029(.003)* | .118(.045)* | — | — | — | — |
| Page | .016(.001)* | −.025(.002)* | .102(.032)* | — | — | — |
| Price | −.156(.029)* | −.020(.008)* | .031(.101) | 1.443(.058)* | — | — |
| Rating | .025(.006)* | −.051(.206) | −.042(.067) | −.039(.012)* | .067(.003)* | — |
| ReviewCnt^{(L)} | .003(.000)* | −.109(.099) | .037(.008)* | .060(.297) | −0.116(.004)* | .217(.040)* |

^{(L)}The natural logarithm form of the variable.
*Significance level at p < 5%.
Note:
SpecialSort is a vector of six control variables indicating the frequency of use of different sorting criteria.

TABLE 8b
Coefficient Estimates from Conversion Model

| | Mean | Class | Price^{(L)} | Rating |
|---|---|---|---|---|
| Intercept | 1.087(.166)* | .057(.011)* | — | — |
| Rank | −.021(.003)* | −.009(.002)* | −.010(.001)* | .015(.005)* |
| Rank² | .002(.000)* | — | — | — |
| Page | −.029(.004)* | −.008(.001)* | −.006(.002)* | .003(.002) |
| Price^{(L)} | −.156(.047)* | .014(.011)* | — | .009(.001)* |
| Rating | .037(.001)* | .002(.003) | −.007(.016) | — |
| ReviewCnt^{(L)} | .019(.001)* | .013(.028) | −.005(.017) | .012(.001)* |
| H^{(L)}(Total #of Hotels) | −.008(.001)* | — | — | — |
| Brand | Yes | | | |
| SpecialSort^{(L)} | Yes | | | |

Unobserved Heterogeneity Estimates (Covariance Matrix Σ^{y})

| | Intercept | Rank | Page | Price | Rating | ReviewCnt(L) |
|---|---|---|---|---|---|---|
| Intercept | 1.225(.032)* | — | — | — | — | — |
| Rank | −.041(.012)* | .089(.022)* | — | — | — | — |
| Page | .038(.007)* | −.070(.031)* | .216(.088)* | — | — | — |
| Price | −.203(.056)* | .104(.051)* | .044(.093) | 2.005(.262)* | — | — |
| Rating | −.159(.234) | .137(.419) | .028(.036) | .077(.032)* | .108(.024)* | — |
| ReviewCnt(L) | .015(.003)* | −.089(.106) | .020(.001)* | .111(.183) | 0.165(.052)* | .304(.086)* |

^{(L)}The natural logarithm form of the variable.
*Significance level at p < 5%.
Note:
SpecialSort is a vector of six control variables indicating the frequency of use of different sorting criteria.

TABLE 8c
Coefficient Estimates from Ranking Model

| | Mean | Class | Price^{(L)} | Rating |
|---|---|---|---|---|
| Intercept | 1.487(.059)* | −.017(.002)* | — | — |
| CRₜ₋₁ | −.121(.014)* | −.005(.010) | −.004(.001)* | .017(.022) |
| Price^{(L)} | .114(.023)* | .002(.003) | — | −.012(.001)* |
| Rating | −.019(.000)* | .019(.027) | — | — |
| ReviewCnt^{(L)} | −.017(.000)* | −.003(.000)* | −.006(.002)* | −.002(.000)* |
| H^{(L)}(Total #of Hotels) | .010(.001)* | — | — | — |

| | |
|---|---|
| Brand | Yes |
| SpecialSort^{(L)} | Yes |

Unobserved Heterogeneity Estimates (Covariance Matrix Σ^{w})

| | Intercept | CRₜ₋₁ | Price | Rating | ReviewCnt^{(L)} |
|---|---|---|---|---|---|
| Intercept | 2.246(.117)* | — | — | — | — |
| CRt_1 | −.107(.033)* | .282(.057)* | — | — | — |
| Price | .114(.012)* | −.095(.040)* | .332(.056)* | — | — |
| Rating | −.201(.023)* | .037(.013)* | −.002(.027) | .838(.126)* | — |
| ReviewCnt(L) | −.032(.002)* | −.043(.155) | .054(.118) | −.069(.033)* | .078(.023)* |

^{(L)}The natural logarithm form of the variable.
*Significance level at p < 5%.
Note:
SpecialSort is a vector of six control variables indicating the frequency of use of different sorting criteria.

TABLE 8d
Coefficient Estimates from Rating Model

| | Mean | Class | Price^{(L)} |
|---|---|---|---|
| Intercept | 2.198(.056)* | .035(.008)* | — |
| Rank | −.028(.007)* | .001(.005) | .003(.002) |
| Rank2 | .004(.001)* | — | — |
| Page | −.007(.000)* | −.002(.000)* | −.004(.000)* |
| Price^{(L)} | .005(.001)* | .001(.003) | — |
| ReviewCnt^{(L)} | .003(.000)* | .006(.011) | .017(.015) |
| H(L)(Total #of Hotels) | .004(.000)* | — | — |

| | |
|---|---|
| Brand | Yes |
| SpecialSort^{(L)} | Yes |

Unobserved Heterogeneity Estimates (Covariance Matrix Σ^{p})

| | Intercept | Rank | Page | Price | ReviewCnt^{(L)} |
|---|---|---|---|---|---|
| Intercept | 4.123(.287)* | — | — | — | — |
| Rank | .195(.046)* | .086(.030)* | — | — | — |
| Page | .086(.025)* | .127(.053)* | .326(.068)* | — | — |
| Price | −.211(.078)* | .061(.080) | −.155(.189) | 2.017(.235)* | — |
| ReviewCnt^{(L)} | .001(.003) | −.098(.105) | .072(.034)* | −.209(.276) | .174(.060)* |

^{(L)}The natural logarithm form of the variable.
*Significance level at p < 5%.
Note:
SpecialSort is a vector of six control variables indicating the frequency of use of different sorting criteria.

TABLE 8e
Covariance Across Clickthrough, Conversion, Rank and Rating Ùjt

| | Clickthrough | Conversion | Rank | Rating |
|---|---|---|---|---|
| Clickthrough | 2.721(.087)* | — | — | — |
| Conversion | 2.006(.043)* | .773(.060)* | — | — |
| Rank | −.214(.022)* | −.626(.051)* | .521(.060)* | — |
| Rating | .835(.067)* | .304(.038)* | −.409(.079)* | .339(.036)* |

*Significance level at p < 5%.

TABLE 9
Model Fit Comparison Results

| | | | | |
|---|---|---|---|---|
| | | | | Model with |
| Main Model | Model with | Model with | | Ordered Probit |
| (Quadratic Rank | Quadratic Rank | Linear Rank | | Term, Partial |
| Term, Full | Term, Partial | Term, Full | Model with | for Rank |
| Heterogeneity | Heterogeneity | Heterogeneity | Linear Rank | Heterogeneity |

In-sample Model Prediction (Click-Through Rate)

| | | | | | |
|---|---|---|---|---|---|
| RMSE | 0.0665 | 0.0759 | 0.0732 | 0.0968 | 0.1020 |
| MSE | 0.0044 | 0.0058 | 0.0054 | 0.0094 | 0.0104 |
| MAD | 0.0102 | 0.0165 | 0.0152 | 0.0282 | 0.0345 |

Out-of-sample Model Prediction (Click-Through Rate)

| | | | | | |
|---|---|---|---|---|---|
| RMSE | 0.0939 | 0.1068 | 0.1134 | 0.1247 | 0.1601 |
| MSE | 0.0088 | 0.0114 | 0.0129 | 0.0156 | 0.0256 |
| MAD | 0.0361 | 0.0427 | 0.0464 | 0.0505 | 0.0963 |

In-sample Model Prediction (Conversion Rate)

| | | | | | |
|---|---|---|---|---|---|
| RMSE | 0.0816 | 0.0996 | 0.0925 | 0.1127 | 0.1445 |
| MSE | 0.0067 | 0.0099 | 0.0086 | 0.0127 | 0.0209 |
| MAD | 0.0183 | 0.0237 | 0.0208 | 0.0389 | 0.0490 |

Out-of-sample Model Prediction (Conversion Rate)

| | | | | | |
|---|---|---|---|---|---|
| RMSE | 0.1164 | 0.1218 | 0.1292 | 0.1573 | 0.1867 |
| MSE | 0.0135 | 0.0149 | 0.0167 | 0.0247 | 0.0349 |
| MAD | 0.0386 | 0.0523 | 0.0479 | 0.0688 | 0.1102 |

TABLE 10
Policy Experiment Results for Search Engine Revenue Prediction

| Ranking | Predicted Revenues from | Predicted Overall Revenues |
|---|---|---|
| Mechanism | Top-1 Rank Hotel ($) | from All Hotels ($) |
| Utility | 1846 | 423,401 |
| CR | 1866 | 415,678 |
| Travelocity | 2210 | 402,349 |
| Default | | |
| Rating | 1739 | 367,662 |
| Price | 2003 | 361,096 |
| CTR | 1476 | 312,757 |

TABLE 11a
Experimental Design - Study I

| | | (Within-Subject) | |
|---|---|---|---|
| | | New York City | Los Angeles |
| (Between- | Treatment | BVR | BVR |
| Subject) | Group 1 | | |
| | Treatment | Price | Price |
| | Group 2 | | |
| | Treatment | TripAdvisor Rating | TripAdvisor Rating |
| | Group 3 | | |
| | Treatment | Travelocity Rating | Travelocity Rating |
| | Group 4 | | |

TABLE 11b
Experimental Design - Study II

(Within-Subject)

| | |
|---|---|
| New York City | Los Angeles |

| | | |
|---|---|---|
| (Between- | Control | Full Access |
| Subject) | Group | |
| | Treatment | No Search Context |
| | Group 1 | |
| | Treatment | No Weight |
| | Group 2 | |

TABLE 12
Experiment Results - Average User Behavior
under Different Ranking Mechanisms

| | Purchase Propensity | Purchase Propensity |
|---|---|---|
| | (NYC) | (LA) |
| BVR (Utility) | 0.88 | 0.93 |
| Price | 0.65 | 0.69 |
| TripAdvisor Rating | 0.54 | 0.44 |
| Travelocity Rating | 0.47 | 0.41 |

Group mean over all users.
Significant (p < 0.05), Post Hoc ANOVA.

TABLE 13
Experiment Results - # of Clicks Received at Top-10 Ranking Positions

| | | Rank1 | Rank2 | Rank3 | Rank4 | Rank5 | Rank6 | Rank7 | Rank8 | Rank9 | Rank10 |
|---|---|---|---|---|---|---|---|---|---|---|---|
| BVR | NYC | 56 | 24 | 13 | 10 | 9 | 11 | 8 | 2 | 1 | 1 |
| | LA | 68 | 20 | 14 | 11 | 10 | 7 | 5 | 4 | 1 | 2 |
| Price | NYC | 25 | 10 | 9 | 9 | 7 | 5 | 2 | 1 | 0 | 0 |
| | LA | 34 | 15 | 10 | 8 | 6 | 4 | 3 | 2 | 0 | 1 |
| TripAdvisor | NYC | 31 | 12 | 8 | 8 | 5 | 4 | 4 | 0 | 1 | 1 |
| | LA | 23 | 15 | 10 | 9 | 4 | 2 | 0 | 1 | 0 | 1 |
| Travelocity | NYC | 23 | 11 | 9 | 6 | 7 | 4 | 4 | 1 | 0 | 2 |
| | LA | 17 | 9 | 8 | 8 | 5 | 3 | 2 | 2 | 0 | 0 |

TABLE 14
Experiment Results - Search Engine Revenue
under Different Ranking Mechanisms

| | Revenues from | Overall Revenues from |
|---|---|---|
| | Top-1 Ranked Hotel ($) | All Hotels ($) |
| BVR (Utility) | 2052 | 7162 |
| Price | 2876 | 6898 |
| TripAdvisor Rating | 1738 | 4350 |
| Travelocity Rating | 1486 | 4002 |

Revenue summed over two cities (NYC and LA).
Significant (p < 0.05), Post Hoc ANOVA.

TABLE 15a
Experiment Results - Interaction Effect between
Ranking Positions and Hotel Class Ratings

| Rank | Luxury (4-, 5-star) | Budget (1-, 2-, 3-star) |
|---|---|---|
| 1→3 | −69% | −43% |
| 1→5 | −75% | −54% |
| 1→10 | −99% | −80% |

Results are based on average CTR.

TABLE 15b
Experiment Results - Interaction Effect between
Ranking Positions and Hotel Customer Ratings

| Rank | Good (4-, 5-star) | Poor (1-, 2-, 3-star) |
|---|---|---|
| 10→5 | 11% | 45% |
| 10→3 | 49% | 166% |
| 10→1 | 83% | 245% |

Results are based on average CTR.

TABLE 16
Experiment Results - Average User Time and Activities
under Different Personalized Ranking Mechanisms

| | Time Spent | Total # |
|---|---|---|
| | (seconds) | of Activities |
| Active Personalized Ranking with Full | 351.23 | 19.36 |
| Access | | |
| Passive Personalized Ranking with No | 228.52 | 16.78 |
| Search Context or Demographics | | |
| Passive Personalized Ranking with No | 127.01 | 8.24 |
| Weights of Individual Preferences | | |

Group mean over all users, across two cities (NYC and LA).
Significant (p < 0.05), Post Hoc ANOVA.

TABLE 17
Experiment Results - User Behavior and Search Engine Revenues
under Different Personalized Ranking Mechanisms

| | # of | # of | Purchase | Purchase | Overall |
|---|---|---|---|---|---|
| | Clicks | Clicks | Propensity | Propensity | Revenues |
| | (NYC) | (LA) | (NYC) | (LA) | ($) |
| Active Personal- | 2.17 | 2.36 | 0.51 | 0.55 | 5103 |
| ized Ranking with | | | | | |
| Full Access | | | | | |
| Passive Personal- | 1.38 | 1.40 | 0.77 | 0.83 | 6631 |
| ized Ranking with | | | | | |
| No Search Con- | | | | | |
| text or Demo- | | | | | |
| graphics | | | | | |
| Passive Personal- | 1.62 | 1.67 | 0.72 | 0.73 | 6254 |
| ized Ranking with | | | | | |
| No Weights of In- | | | | | |
| dividual Prefer- | | | | | |
| ences | | | | | |

Group mean over all users.
Significant (p < 0.05), Post Hoc ANOVA.

TABLE 18
Experiment Results - Negative Binomial Model on # of Clicks

| | Coeff. | Coeff. | Coeff. |
|---|---|---|---|
| NOSEARCH | −.891* (.362) | −.889* (.371) | −.773* (.242) |
| NOWEIGHT | −.577* (.230) | −.569* (.238) | −.494* (.201) |
| City | No | Yes | Yes |
| Activities | No | No | Yes |
| Log pseudolikelihood | −176.56322 | −176.54825 | −155.10346 |

*Significance level at p < 5%.

TABLE 19
Experiment Results - Probit Model on Purchase Propensity

| | Coeff. | Coeff. | Coeff. |
|---|---|---|---|
| NOSEARCH | .587* (.233) | .581* (.228) | .591* (.219) |
| NOWEIGHT | .076 (.096) | .080 (.089) | .167* (.093) |
| City | No | Yes | Yes |
| Activities | No | No | Yes |
| Log pseudolikelihood | −341.00704 | −340.88529 | −318.09032 |

*Significance level at p < 5%.

TABLE 20
Experiment Results - Robustness Test (1)

| | Time | Total | # of | # of | Purchase | Purchase | Overall |
|---|---|---|---|---|---|---|---|
| | Spent | # of | Clicks | Clicks | Propensity | Propensity | Revenues |
| | (seconds) | Activitie | (NYC) | (LA) | (NYC) | (LA) | ($) |
| High-Level Active | 343.02 | 19.27 | 2.28 | 2.42 | 0.45 | 0.44 | 4622 |
| Personalized Ranking with | | | | | | | |
| Full Access | | | | | | | |
| Passive Personalized | 228.52 | 16.78 | 1.38 | 1.40 | 0.77 | 0.83 | 6631 |
| Ranking with No Search | | | | | | | |
| Context or Demographics | | | | | | | |
| Passive Personalized | 127.01 | 8.24 | 1.62 | 1.67 | 0.72 | 0.73 | 6254 |
| Ranking with No Weights | | | | | | | |
| of Individual Preferences | | | | | | | |

TABLE 21
Experiment Results - Robustness Test (2)

| | Time | Total | Purchase | Purchase |
|---|---|---|---|---|
| | Spent | # of | Propensity | Propensity |
| | (seconds) | Activities | (NYC) | (LA) |
| Active Personalized | 351.23 | 19.36 | 0.51 | 0.55 |
| Ranking with a | | | | |
| Planned Purchase | | | | |
| Active Personalized | 177.01 | 18.18 | 0.75 | 0.69 |
| Ranking with an | | | | |
| Unplanned Purchase | | | | |

### EXEMPLARY REFERENCES

The following references are hereby incorporated by reference in their entireties:
[1] Agarwal, A., K. Hosanagar, M. Smith. 2011. Location, Location, Location: An Analysis of Profitability of Position in Online Advertising Markets. Journal of Marketing Research, 48(6).
[2] Aula, A. and K. Rodden. 2009. Eye-tracking studies: More than meets the eye. http://googleblog.blogspot.com/ 2009/02/eye-tracking-studies-more-than-meets.html
[3] Baye, M. R., Gatti, J. R. J., Kattuman, P. and Morgan, J. 2009. Clicks, Discontinuities, and Firm Demand Online. Journal of Economics & Management Strategy. 18(4), 935-975.
[4] Berry, S., Levinsohn, J., and Pakes, A. 1995. Automobile prices in market equilibrium. Econometrica, 63, 841-890.
[5] Branco, F., M. Sun, and J. M. Villas-Boas. 2012. Optimal Search for Product Information, Management Science, forthcoming.
[6] Bronnenberg, B., P. Albuquerque, and J. B. Kim. 2012. Modeling Optimal Search and Choice Decisions: The Role of Uncertainty, Innovation, and Consumer Reviews. Working Paper.
[7] Brynjolfsson, E., A. Dick and M. Smith. 2010. A nearly perfect market? Differentiation vs. price in consumer choice. Quantitative Marketing and Economics, vol. 1.8, no. 1.
[8] Caplin, Andrew, Mark Dean, and Daniel Martin. 2011. Search and Satisficing. American Economic Review, 101(7): 2899-2922.
[9] Chapelle, O. and Zhang, Y. 2009. A Dynamic Bayesian Network Click Model for Web Search Ranking. Proceedings of WWW 2009, Madrid, Spain.
[10] Chen, Y. and S. Yao. 2012. Search with Refinement. Working Paper.
[11] Chiang, J., S. Chib, C. Narasimhan 1999. Markov chain Monte Carlo and models of consideration set and parameter heterogeneity. Journal of Econometrics 89(1-2) 223-248.
[12] De los Santos, B. 2008, Consumer search on the internet, PhD dissertation, Chicago University.
[13] De los Santos, B., A. Hortacsu, and M. Wildenbeest. 2011. Testing models of consumer search using data on web browsing and purchasing behavior. Working paper.
[14] Dellaert, B. G. C., G. Häubl. 2012. Searching in Choice Mode: Consumer Decision Processes in Product Search with Recommendations. Journal of Marketing Research. Vol. 49, No. 2, pp. 277-288.
[15] Ellison, G. and Ellison, S. F. 2009. Search, Obfuscation, and Price Elasticities on the Internet. Econometrica, 77, 427-452.
[16] Erdem, T. and Keane, M. P. 1996. Decision-Making Under Uncertainty: Capturing Dynamic Brand Choice Processes in Turbulent Consumer Goods Markets. Marketing Science. vol. 15 no.11-20.
[17] Ghose, A. and Ipeirotis, P. G. 2011. Estimating the helpfulness and economic impact of product reviews: Mining text and reviewer characteristics. IEEE Transactions on Knowledge and Data Engineering, 23 (10), 1498-1512.
[18] Ghose, A., Iperotis, P. and Li, B. 2012. Designing Ranking Systems for Hotels on Travel Search Engines by Mining User-Generated and Crowdsourced Content. Marketing Science. 31(3), May-June 2012, 493-520.
[19] Ghose A, and Yang, S. 2009. An Empirical Analysis of Search Engine Advertising: Sponsored Search in Electronic Markets. Management Science. 55(10), pp. 1605-1622.
[20] Goldfarb, A. and Tucker, C. 2011. Search Engine Advertising: Channel Substitution When Pricing Ads to Context. Management Science, 57:458-470.
[21] Hann, I., & Terwiesch, C. 2003. Measuring the frictional cost of online transactions: The case of a name-your-own-price channel. Management Science, 49, 1563-1579.
[22] Hong, H. and M. Shum. 2006. Can search cost rationalize equilibrium price dispersion in online markets? Rand Journal of Economics, 37 (2): 258.276.
[23] Honka, E. 2012. Quantifying search and switching costs in the U.S. auto insurance industry. Working paper, SSRN.
[24] Hortacsu, A. and C. Syverson. 2004. Product Differentiation, Search Costs, and Competition in the Mutual Fund Industry: A Case Study of S&P 500 Index Funds, Quarterly Journal of Economics, 119: 403.456 (May 2004).
[25] Iprospect. 2008. iProspect Blended Search Results Study. http://www.herramientas-seo.com/pdfestudio-buscadores-iprospect.pdf.
[26] Johnson, E., W. W. Moe, P. S. Fader, S. Bellman, and G. L. Lohse. 2004. On the Depth and Dynamics of On-line Search Behavior, Management Science, 50 (3): 299.308.
[27] Jonassen, S., B. B. Cambazoglu, F. Silvestri. 2012. Prefetching Query Results and its Impact on Search Engines. SIGIR'12, August 12-16, 2012, Portland, Oreg., USA.
[28] JupiterResearch. 2006. Retail Web Site Performance. http://www.akamai.com/4seconds.
[29] Kahneman, D. and Tversky, A. 1979. Prospect theory: An analysis of decision under risk. Econometrica, 47(2):263-292.
[30] Kim, J., P. Albuquerque, and Bart J. Bronnenberg. 2010. Online Demand under Limited Consumer Search, Marketing Science, 29(6), pp. 1001-1023.
[31] Koulayev, Sergei. 2010. Estimating Demand in Online Search Markets, with Application to Hotel Bookings. Working Paper.
[32] Lempel, R. and S. Moran. 2003. Predictive caching and prefetching of query results in search engines. In Proc. 12th Int'l Conf. World Wide Web, pages 1928, 2003.
[33] McFadden, D. 1974. Conditional Logit Analysis of Qualitative Choice Behavior, in Zarembka, Paul, ed., FRONTIERS IN ECONOMETRICS, Academic Press: New York, 105-142.
[34] McFadden, D. and K. Train. 2000. Mixed MNL Models of Discrete Response. Journal of Applied Econometrics. 15, 447-470.
[35] Mehta, N., S. Rajiv, and K. Srinivasan. 2003. Price uncertainty and consumer search: a structural model of consideration set formation, Marketing Science, 22(1).
[36] Moraga-Gonzalez, J. L. and Wildenbeest, M. R. 2008. Maximum likelihood estimation of search costs. European Economic Review, 52, 820-48.
[37] Moraga-Gonzalez, J. L., Sandor, Z. and Wildenbeest, M.R. 2011. Consumer Search and Prices in the Automobile Market. Working Paper.
[38] Mortensen, D. T. 1970. Job search, the duration of unemployment and the Phillips curve, American Economic Review, 847-62.
[39] Pieters, R. and Warlop, L. 1999. Visual attention during brand choice: The impact of time pressure and task motivation. International Journal of Research in Marketing, 16:1-16.
[40] Reinganum, J. F. 1982. Strategic search theory. International Economic Review. 23(1) 1-15.
[41] Reinganum, J. F. 1983. Nash equilibrium search for the best alternative. J. Econom. Theory 30(1) 139-152.
[42] Simon, H. A. 1955. A behavioral model of rational choice. The Quarterly Journal of Economics, 69(1):99-118.
[43] Sorensen, A. T. 2001. Price dispersion and heterogeneous consumer search for retail prescription drugs. NBER working paper 8548.
[44] Stigler, G.J. 1961. The Economics of Information. The Journal of Political Economy, Volume 69, Issue 3 (Jun., 1961), 213-225.
[45] Weitzman, M. L. 1979. Optimal search for the best alternative. Econometrica 47(3) 641-654.
[46] Wildenbeest, M. R. 2011. An Empirical Model of Search with Vertically Differentiated Products. Forthcoming in RAND Journal of Economics.
[47] Yao, S., C. F. Mela. 2011. A Dynamic Model of Sponsored Search Advertising. Marketing Science, 30(3), pp. 447-468.
[48] Abhishek, V., K. Hosanagar and P. Fader. 2011. Aggregation Bias in Sponsored Search Data: The Curse and The Cure. SSRN Working Paper.
[49] Ansari, A., and Mela, C. F. 2003. E-customization. Journal of Marketing Research, 40(2), 131-145.
[50] Aral, S. and D. Walker. 2011. Creating Social Contagion Through Viral Product Design: A Randomized Trial of Peer Influence in Networks. Management Science. 57(9), 1623-1639.
[51] Arora, N., and Henderson, T. 2007. Embedded premium promotion: Why it works and how to make it more effective. Marketing Science, 26(4), 514-531.
[52] Chevalier, J. and D. Mayzlin. 2006. The Effect of Word of Mouth on Sales: Online Book Reviews. Journal of Marketing Research. Vol. XLIII, 345-354.
[53] Chib, S., E. Greenberg. 1995. Understanding the Metropolis-Hastings algorithm. The American Statistician, 49(4), 327-335.
[54] Chittor, V. 2010. Online Retail: Getting The Right Product in Front of Your Customers. http://www.inc.com/internet/articles/201002/chittoor.html.
[55] Dellarocas, C. 2012.Double Marginalization in Performance-based Advertising: Implications and Solutions. Management Science, 58 (6), 1178-1195.
[56] De Los Santos, B. and S. Koulayev. 2012. Optimizing Click-through in Online Rankings for Partially Anonymous Consumers, Working Paper, Indiana University.
[57] Dodds, W. B., Monroe, K. B., and Grewal, D. 1991. Effects of Price, Brand, and Store Information on Buyers' Product Evaluations. Journal of Marketing Research, 28 (3), 307-319.
[58] Dyzabura, D. 2012. Product Search as Consumers Learn Their Preferences Through Product Evaluation. Working Paper, New York University.
[59] Jerath, K., L. Ma, Y. Park and K. Srinivasan. 2011. A “Position Paradox” in Sponsored Search Auctions. Marketing Science, 30 (4), 612-627.
[60] Kuksov, D. and Villas-Boas, J. M. 2010. When More Alternatives Lead to Less Choice. Marketing Science. 29(3), 507-524.
[61] Lambrechet, A. and C. Tucker 2012. When Does Retargeting Work? Timing Information Specificity, Working paper, SSRN.
[62] Li, Xinxin and Hitt, Lorin M. 2010. Price Effects in Online Product Reviews: An Analytical Model and Empirical Analysis. MIS Quarterly, 34(4), 809-831.
[63] Malthouse, E. C., and Elsner, R. 2006. Customization With Cross-basis Sub-segmentation. Database Marketing & Customer Strategy Management, 14(1), 40-50.
[64] Moe, W. and P. S. Fader. 2003. Dynamic Conversion Behavior at e-commerce Sites. Management Science. 50(3) 326-335.
[65] Narayanan, S. and K. Kalyanam. 2011. Measuring Position Effects in Search Advertising: A Regression Discontinuity Approach. Working Paper.
[66] Nevo, A. 2001. Measuring Market Power in the Ready-to-Eat Cereal Industry, Econometrica, 69(2), 307-342.
[67] Ranjith, G. 2005. Interferon-a-Induced Depression: When a Randomized Trial Is Not a Randomized Controlled Trial, Psychother Psychosom, 74(6):387.
[68] Rossi, P. E., McCulloch, R. E., and Allenby, G. M. 1996. The Value of Purchase History Data in Target Marketing. Marketing Science, 15(4), 321-340.
[69] Rossi, P. E. and Greg M. Allenby. 2003. Bayesian Statistics and Marketing. Marketing Science, 22(3), 304-328.
[70] Rutz, O. and R.E. Bucklin. 2007. A Model of Individual Keyword Performance in Paid Search Advertising. Working paper, Yale University, New Haven, CT.
[71] Rutz, 0. J. and M. Trusov. 2011. Zooming In on Paid Search Ads—A Consumer-Level Model Calibrated on Aggregated Data. Marketing Science, 30(5), 789-800.
[72] Yang, S. and A. Ghose. 2010. Analyzing the Relationship Between Organic and Sponsored Search Advertising: Positive, Negative, or Zero Interdependence? Marketing Science, 29(4), 602-623.
[73] Yao, S. and C. F. Mela. 2011. A Dynamic Model of Sponsored Search Advertising. Marketing Science, 30(3), 447-468.
[74] Zhang, J. and Wedel, M. 2009. The Effectiveness of Customized Promotions in Online and Offline Stores. Journal of Marketing Research. 46(2), 190-206.

What is claimed is:

1. A non-transitory computer-accessible medium having stored thereon computer-executable instructions for determining a search behavior of at least one first consumer, wherein, when a computer hardware arrangement executes the instructions, the computer arrangement is configured to perform procedures comprising:
receiving information related to the at least one first consumer; and
determining the search behavior of the at least one first consumer based on the information and using a consumer search model that is based on heterogeneous preferences and a search cost model of at least one second consumer.

2. The computer-accessible medium of claim 1, wherein the search cost model includes a random coefficient function.

3. The computer-accessible medium of claim 2, wherein the random coefficient function is based on a specific product.

4. The computer-accessible medium of claim 1, wherein the search cost model is based on social media information.

5. The computer-accessible medium of claim 4, wherein the social media information includes information related to at least one specific product.

6. The computer-accessible medium of claim 1, wherein the search cost model is based on a cost for refining a search.

7. The computer-accessible medium of claim 1, wherein the search cost model is based on a lognormal distribution.

8. The computer-accessible medium of claim 1, wherein the search cost model is based on a mean search cost of an observed average size of a search-generated consideration set of the at least one second consumer

9. The computer-accessible medium of claim 1, wherein the consumer search model is further based on at least one transaction of the at least one second consumer.

10. The computer-accessible medium of claim 1, wherein the consumer search model is further based on at least one click-through from each ranking position on a page of at least one product.

11. The computer-accessible medium of claim 1, wherein the consumer search model is further based on at least one effort of the at least one second consumer to refine a search procedure.

12. The computer-accessible medium of claim 1, wherein the consumer search model is further based on a hierarchical Bayesian framework.

13. The computer-accessible medium of claim 1, wherein the computer hardware arrangement is further configured to cache a webpage that the at least one first consumer is likely to visit based on the search behavior.

14. The computer-accessible medium of claim 1, wherein the computer hardware arrangement is further configured to generate a ranking procedure for the at least one first consumer based on the search behavior.

15. The computer-accessible medium of claim 1, wherein the information is at least one of a current search history of the at least one first consumer or a previous search history of the at least one first consumer.

16. The computer-accessible medium of claim 1, wherein the search behavior of the at least one first consumer includes a probability that the at least one first consumer will at least one of click on a specific product or a purchase the specific product.

17. The computer-accessible medium of claim 1, wherein the heterogeneous preferences are based on search data of the at least one second consumer.

18. The computer-accessible medium of claim 17, wherein the search data is based on a difference between a predicted click probability of the at least one second consumer and an observed click probability of the at least one second consumer.

19. The computer-accessible medium of claim 1, wherein the computer hardware arrangement is further configured to generate the search cost model using a Maximum Simulated Likelihood (MSL) procedure.

20. The computer-accessible medium of claim 19, wherein the MSL procedure is a Monte Carlo procedure.

21. A method for determining a search behavior of at least one first consumer, comprising:
receiving information related to the at least one first consumer; and
using a computer hardware arrangement, determining the search behavior of the at least one first consumer based on the information and using a consumer search model that is based on heterogeneous preferences and a search cost model of at least one second consumer.

22. A system for determining a search behavior of at least one first consumer, comprising:
a computer hardware arrangement configured to:
receive information related to the at least one first consumer; and
determine the search behavior of the at least one first consumer based on the information and using a consumer search model that is based on heterogeneous preferences and a search cost model of at least one second consumer.
